(19) United States
(12) Patent Application Publication
(10) Pub. No.: US 2025/0310722 A1
(43) Pub. Date: Oct. 2, 2025

(54) ACCOUNTING FOR ARCHITECTURAL DIVERSITY WHEN LOCATING DEVICES

(71) Applicant: APPLE INC., Cupertino, CA (US)

(72) Inventors: Benjamin A. Werner, San Jose, CA (US); Zachary Clute, San Francisco, CA (US); Tunc Ertan, Santa Clara, CA (US); Anup Dhital, San Jose, CA (US)

(73) Assignee: APPLE INC., Cupertino, CA (US)

(21) Appl. No.: 19/092,904

(22) Filed: Mar. 27, 2025

Related U.S. Application Data
(60) Provisional application No. 63/571,400, filed on Mar. 28, 2024.

(51) Int. Cl. H04W 4/02; H04B 17/318

(52) U.S. Cl. CPC H04W 4/025; H04B 17/328

(57) ABSTRACT

A finding process may determine the orientation of a handheld user device and select the antenna for locating a findable device based on the orientation of the handheld user device. The selection may be further improved by incorporating signal measurements from the findable device, such as the received signal strength indicator (RSSI) or the antenna patterns of the handheld user device antennas. The handheld user device may perform location-based or time-based filtering on the measurements of signals received from the findable device on one or more antennas of the handheld user device. The handheld user device may perform pattern matching using the measured RSSIs and antenna patterns to identify the location of the findable device. The user interface may include graphical images that are continuously updated to indicate the distance to and location of the findable device.

### CROSS-REFERENCES TO OTHER APPLICATIONS

This application claims priority to U.S. Provisional Application No. 63/571,400, for “ACCOUNTING FOR ARCHITECTURAL DIVERSITY WHEN LOCATING DEVICES” filed on Mar. 28, 2024, which is herein incorporated by reference in its entirety for all purposes.

### BACKGROUND

User devices may use a finding application to keep track of linked or connected accessory devices. The finding application may communicate with the accessory devices via a wireless network or via a cloud-connected server that has received the location of the accessory device.

Some user devices, such as large handheld tablets, may include multiple antennas. The antennas are often located at the sides or edges under the chassis. There are many ways that users may hold these large handheld tablets. Sometimes, one or more of the antennas may be covered by the user's hand holding the device, causing an additional attenuation to the received signal.

The attenuation of the received signal caused by the user's grip can impact the performance of the finding application in locating the linked or connected accessory devices.

### BRIEF DESCRIPTION OF THE DRAWINGS

FIG. 1 illustrates a finding environment in accordance with some embodiments.

FIG. 2 illustrates examples of orientation-based antenna selection in accordance with some embodiments.

FIG. 3 illustrates a flow diagram in accordance with some embodiments.

FIG. 4 illustrates signal diagrams in accordance with some embodiments.

FIG. 5 illustrates an example of the impact of antenna patterns on received signals in accordance with some embodiments.

FIG. 6 illustrates a flow diagram in accordance with some embodiments.

FIG. 7 illustrates examples of orientation and antenna pattern in accordance with some embodiments.

FIG. 8 illustrates signal diagrams in accordance with some embodiments.

FIG. 9 illustrates an example of a likelihood-based finding process in accordance with some embodiments.

FIG. 10 illustrates signal diagrams in accordance with some embodiments.

FIG. 11 illustrates signal diagrams in accordance with some embodiments.

FIG. 12 illustrates a flow diagram in accordance with some embodiments.

FIG. 13 illustrates an example of a finding process in accordance with some embodiments.

FIG. 14 illustrates a flow diagram in accordance with some embodiments.

FIG. 15 illustrates examples of graphical interfaces in accordance with some embodiments.

FIG. 16 illustrates examples of graphical interfaces in accordance with some embodiments.

FIG. 17 illustrates examples of graphical interfaces in accordance with some embodiments.

FIG. 18 illustrates a flow diagram in accordance with some embodiments.

FIG. 19 illustrates a flow diagram in accordance with some embodiments.

FIG. 20 illustrates a flow diagram in accordance with some embodiments.

FIG. 21 is a block diagram of an example device according to the embodiments of the present disclosure.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

### I. Overview

Handheld user devices may include one or more communication modules (including hardware and software components). Each radio module may include transceiver circuitry, including one or more antennas. The antennas may be located under the chassis and sometimes at the edges.

Handheld user devices, e.g., smartphones or tablets, may have different form factors. Even one device may have different stock-keeping units (SKUs), each having a different form factor. The form factor may impact a user's preference for holding a handheld user device. For example, while the user may hold a smartphone in one hand resting on their palm, the user may hold a tablet with both hands in a landscape or portrait orientation.

In some embodiments, the user may use the handheld user device to locate an accessory device capable of connecting with the handheld user device. The accessory device that can be found by the handheld user device may be referred to as a findable device. For example, the user may use an application on their handheld user device to locate a stylus, or remote controls. The handheld user device may analyze the signals it receives from the findable device to estimate the location of the findable device. A graphical interface displayed on the screen of the handheld user device may guide the user towards the findable device.

In some embodiments, the handheld user device may locate the accessory device based on the wireless signal it receives from the accessory device. The handheld user device may compute the distance of the accessory device from the handheld user device, the angle of arrival of the signal from the accessory device, or the relative location of the accessory device with respect to the handheld user device by analyzing the wireless signals received from the accessory device. The wireless signals from the accessory device may be Bluetooth, Bluetooth low energy (BLE), WiFi, or ultra-wideband signals.)

In an example use case, a user may open a finding application on their handheld user device, e.g., a tablet, to locate an accessory device, e.g., a stylus or other accessory device. The user may select the stylus on the application's graphical user interface. Selecting the stylus may initiate a finding session. When the tablet initiates a finding procedure to locate the stylus, the handheld user device may send a request to the stylus. The request may cause the stylus to transmit signals. For example, the tablet may request the stylus to transmit Bluetooth or BLE rapid advertisement signals. The tablet may use the transmitted signals from the stylus to find the location of the stylus and display it on the application's graphical user interface in a way that guides the user to the location of the stylus.

The user may hold the tablet and follow the indicators on the screen to find the stylus. The user's grip may obscure one or more antennas of the tablet, causing a degradation in the signal quality of the stylus that is received by the obscured antenna. The degradation in signal quality may consequently impact the accuracy of locating the stylus. It is desirable to use the signals received on unobscured antennas to use the best quality signals available.

Depending on the form factor, the location of antennas, the orientation of the tablet, and the most common ways users may hold the tablet in a given orientation of the tablet, a probability or likelihood of being obscured can be assigned to the antennas of the tablet. The probability or likelihood values can be obtained through user experience field tests.

Similarly, an average power degradation can be assigned to each antenna of the tablet based on the above factors. The average power degradation for different form factors, orientations, or SKUs can be obtained through user experience field tests.

In some embodiments, for a given form factor or SKU of the tablet, the corresponding power degradation or probability of being obscured of each antenna for different orientations of the tablet may be configured and stored in the device. Such configuration may be done during the manufacturing or calibration of the tablet.

The finding application, with additional information from other components of the device, may determine the orientation of the tablet. Using the configured table, the finding application may determine the probability of each antenna of the device being obscured or may determine the received signal power drop, if any, for each antenna of the device.

Based on the power drop information or the probability values of being obscured by the antennas, the finding application or other hardware or software components of the tablet may determine one or more antennas whose received signals may be used to locate the stylus. The finding application may use the signals from one antenna having the strongest signal, e.g., the smallest power drop or the smallest likelihood of being obscured. In some embodiments, the tablet, e.g., the finding application, may use the signals from more than one antenna, combine the signals from those antennas, and use the combined signals to locate the stylus.

In some embodiments, the finding application may prompt the user to change the orientation of the device. For example, based on the configured information of power drop or likelihood of being obscured for given orientations, the tablet may determine the preferred orientation and one or more preferred antennas having the strongest signal quality or strength compared to the signal strength of all antennas in all orientations. If the tablet's orientation is different from the preferred orientation while finding the stylus, the finding application may prompt the user to change the orientation. The finding application may also suggest the user hold the table in the preferred orientation. To ensure that the user's grip does not obscure the optimum antennas, the finding application may also prompt the user to hold the device or identify the areas not to be used for holding the tablet. The application may communicate the optimum orientation, grip, or areas to be avoided for holding the tablet on the graphical user interface.

In some embodiments, it may be less desirable to prompt the user to adjust the orientation of the tablet. The techniques described herein may utilize additional characteristics of the antennas and their signals to improve finding or locating the stylus. For example, the antenna pattern is a characteristic of an antenna and may be used as part of the techniques described herein. The antenna pattern may indicate how the antenna radiates or receives energy in different directions. In some embodiments, the antenna pattern of each antenna of the user device, e.g., the tablet, may be measured and stored in the tablet. The antenna pattern of the antennas may be measured during the manufacturing or calibration of the device and may be configured or stored in the device.

In some embodiments, the tablet may select one or more antennas based on the orientation of the tablet, the configured power drop or likelihood of being obscured, and the antenna pattern of one or more antennas of the tablet. For example, having an estimate of the location of the stylus, the tablet can determine the antenna with the strongest signal based on the antenna pattern of the antennas, the estimated location of the stylus, or the power drop or likelihood of being obscured for the current orientation of the device.

In another embodiment, based on the configured information of power drop or likelihood of being obscured for given orientations, the antenna pattern of the antennas of the tablet, and the estimated location of the stylus, the tablet may determine the optimum orientation and one or more optimum antennas having the strongest signal quality or strength compared to the signal strength of other antennas in all orientations. If the tablet's current orientation is different from the optimum orientation while finding the stylus, the finding application may prompt the user to change the orientation. The finding application may also suggest the user hold the table in the optimum orientation. To ensure that the user's grip does not obscure the optimum antennas, the finding application may also prompt the user to hold the device or identify the areas not to be used for holding the tablet. The application may communicate the optimum orientation, grip, or areas to be avoided for holding the tablet on the graphical user interface.

In some embodiments, the tablet may use the signal of the optimum antenna to locate the stylus. In other embodiments, the tablet may use the signals from one or more antennas to locate the stylus. The signals of the antennas may be combined to obtain a combined signal. The tablet may use the combined signal to locate the stylus.

In some embodiments, e.g., when there are signals on two channels, the tablet may choose the channel with the strongest signal. For example, the stylus may transmit Bluetooth signals on multiple channels, e.g., carrier frequencies. The tablet may choose the Bluetooth channel with the strongest signal. In another example, the stylus signal may be received on multiple antennas (e.g., multiple channels). The tablet may choose the antenna with the strongest signal as the receiving antenna and may analyze the signals on the selected antenna to locate the stylus.

The signal strength may be determined by sampling the received signal and calculating the power of the measured samples. Multiple power measurements may also be averaged to obtain a single measurement result that may represent the signal strength for the duration of the measurement. The signal strength may be quantized and identified by the corresponding quantization index. Such representation of the signal strength may be referred to as the received signal strength indicator (RSSI). The larger the value of the RSSI, the stronger the received signal.

In some instances, an average value of multiple RSSIs may be used to select a channel or antenna. In one example, several RSSIs sampled in regular time instances are averaged. However, such time-based averages may not choose the best channel or antenna. For example, suppose the user mobility is low, and the RSSI samples are all collected while the user is in a temporary bad location for a channel. In that case, the tablet may choose the channel based on negatively biased samples for the bad channel. Another way to obtain the average RSSI is to sample RSSI while the user moves a distance, e.g., a linear or a rotational or angular displacement. Using distance-based RSSI filtering (e.g., averaging) may reduce the negative bias and improve the likelihood of choosing the best channel or antenna.

In some embodiments, the tablet may determine that the tablet has moved a distance. The tablet may receive signals from the stylus on a plurality of channels while the tablet moves the distance, where the channels may be different radio frequencies or may be different antennas. The tablet may perform the signals' measurements (e.g., RSSI measurements) to compute a measurement result (e.g., filtered or averaged RSSIs) for each channel of the plurality of channels based on the measurements. Based on the measurement results, the tablet may select a channel of the plurality of channels. Using the measurement result, the tablet may determine the relative location of the stylus with respect to the location of the tablet based on the selected channel's measurement result.

In some embodiments, the tablet may receive signals associated with the stylus at an antenna of the handheld user device. The tablet may perform measurements of the signals. Using the measurement and the configured information of the antenna pattern, the tablet may determine the relative location of the findable device with respect to the location of the handheld user device based on the measurements and the antenna pattern. For example, given the received values of RSSI measured at different locations and the antenna pattern, the tablet may estimate the angle of arrival of the signals from the stylus that could result the measured RSSIs. Using the ranging techniques and having the angle of arrival, the tablet may estimate the location of the stylus.

In some embodiments, the finding application may generate a user interface to be displayed on the screen of a handheld user device. The user interface may include a textual portion and a graphical portion. The process may determine the distance between the stylus and the tablet based on the received signal from the stylus. The finding application may determine a text to be displayed on the textual portion of the user interface based on the received signal or the distance. Additionally, or alternatively, the finding application may determine one or more images with one or more characteristics to be displayed on the graphical portion of the user interface, where the process may determine one or more characteristics of one or more images based on the signal. For example, the size or orientation of the image may be based on the signal strength or an estimated distance between the tablet and the stylus. The characteristics of the image may be updated continuously as the user moves around in search of the stylus.

In accordance with the techniques described herein, the location of the accessory device may be determined. In one example, the tablet may use the RSSI from BLE beacons to estimate the distance between the stylus and the tablet. In another example, multichannel transmission may be used to improve the performance of BLE-based localization. Techniques such as time or arrival (TOA), time difference of arrival (TDOA), angle of arrival (AOA), and angle difference of arrival (ADOA) may be used to infer the position based on the time it takes for a signal to travel from the transmitter to the receiver. In another example, convolutional neural network (CNN) based localization techniques may be used. This method converts the localization problem into a regression problem using a CNN. In another example, the Kalman filter-based localization technique may be used.

### II. System Environment

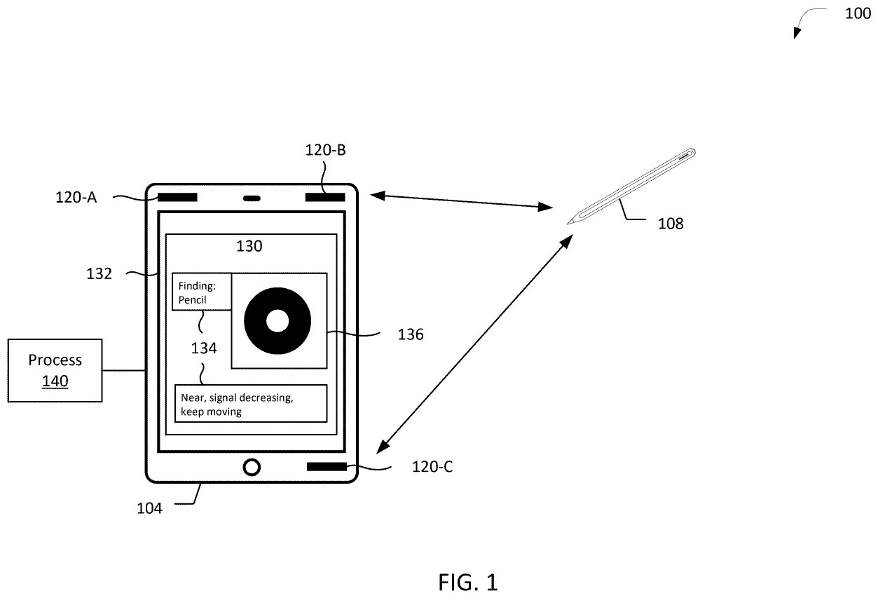

FIG. 1 illustrates a finding environment 100 in accordance with some embodiments. The environment 100 may include a handheld user device 104 and a findable device 108. The handheld user device 104 may be communicatively coupled with the findable device 108. For example, handheld user device 104 may be paired with findable device 108 via a communication link in accordance with Bluetooth, WiFi, or cellular protocols.

A process 140, e.g., an application or daemon, may run on handheld user device 104. Process 140 may be a finding application used to locate findable devices, e.g., accessories and other devices such as findable device 108, coupled with handheld user device 104.

Handheld user device 104 may include one or more antennas, e.g., antennas 120-A/B/C. One or more antennas may receive signals from the findable device 108. For example, process 140 may receive signals from findable device 108 on its antennas, e.g., antennas 120-A/B/C. Process 140 may locate the findable device 108 by analyzing the received signals. In some instances, the user may move in search of the findable device, and the signals may be obtained at different times or locations. In some instances, antennas 120-B and 120-C may receive Bluetooth signals from findable device 108.

Handheld user device 104 may include a screen 132. Process 140 may use a user interface 130 to display information on screen 132 related to the location of the findable device 108. User interface 130 may include one or more textual portions 134. One or more textual portion 134 may display information about the device being located, an indication of whether the findable device is close or far, or guiding instructions such as direction of movement.

Additionally, or alternatively, user interface 130 may include one or more graphical portions 136. The one or more graphical portions 136 may include one or more user interface elements. The user interface elements may include one or more images. One user interface element may indicate the received signal strength or distance to the findable device 108. One or more graphical portions 136 may include one or more user interface elements to indicate the relative location of the findable device 108 or a direction of movement guiding the user toward the findable device 108.

As the user moves toward the findable device 108 with handheld user device 104 in their hand, process 140 may continue receiving and analyzing signals from findable device 108. Process 140 may recalculate the relative location of findable device 108 with respect to the location of handheld user device 104 and update the information displayed on user interface 130.

### III. Orientation-Based Antenna Selection

The user may hold the device in different orientations, e.g., portrait or landscape. At a given orientation, some of the antennas are more likely to be obscured by the user's hand grip, and others are more likely not to. The process may select an antenna that is less likely to be obscured and use the signals received on that antenna to locate the findable device.

### DESCRIPTION

The field test may be performed to determine different orientations and hand locations used by users to hold the device while searching for an accessory device. The power drop on each antenna due to the hand grip and orientation can be configured and stored in the device. The handheld user device may select the antenna based on the configured information and the orientation of the device.

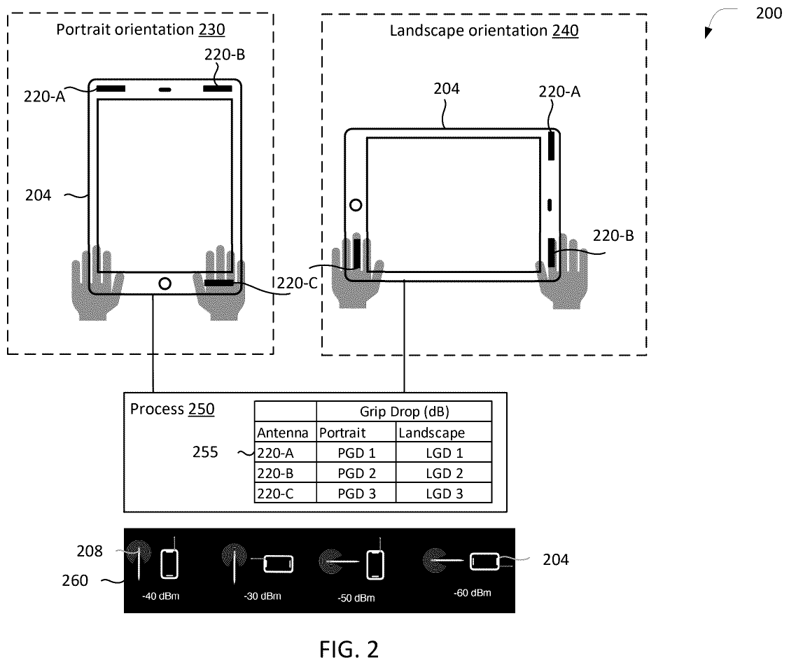

FIG. 2 illustrates an example of orientation-based antenna selection 200 in accordance with some embodiments. Handheld user device 204 may be an example of handheld user device 104 in FIG. 1. Handheld user device 204 may include antennas 220-A/B/C.

The location of antennas in handheld user device 204 may depend on its form factor and the characteristics of the specific device (e.g., SKU). For example, the location of antennas in a tablet with only WiFi capability may differ from the location of the antenna in a similar model tablet with both WiFi and cellular capabilities. The location of antennas, the power drop or likelihood of being obscured by user grip at different orientations, and other information, such as the antenna pattern of each device, may be configured and stored in the device. The finding application or other applications or processes on the handheld user device may have access to the configured or stored information.

In some instances, when the user holds the handheld user device 204 in portrait orientation 230, antenna 220-C may be obscured, e.g., by the user's hand. In other instances, when the user holds the handheld user device 204 in landscape orientation 240, antennas 220-C and 220-B may be obscured, e.g., by the user's hand.

Process 250 may determine the orientation of handheld user device 204. For example, process 250 may use the information received from an accelerometer, a gyroscope, a magnetometer, or other sensor of handheld user device 204 to determine the device's orientation.

Based on the orientation of the handheld user device 204, process 250 may select antennas to be used to locate the findable device. For example, process 250 may determine that handheld user device 204 is in portrait orientation 230 and may accordingly select antennas 220-A or 220-B for locating the findable device. In another example, process 250 may determine that handheld user device 204 is in landscape orientation 240 and may accordingly select antenna 220-A for locating the findable device.

In some embodiments, process 250 may reference table 255. Table 255 may include the received signal power drop in decibels (dB) for different orientations. Table 255 may have an antenna column listing handheld user device 204 antennas, e.g., 220-A/B/C. Table 255 may include a column for grip drop power associated with portrait orientation 230, e.g., values PGD 1-3, and another column for grip drop power associated with landscape orientation 240, e.g., values LGD 1-3. As used herein, the term “grip drop” can refer to the received signal power drop (in dB) of an antenna due to a user's hand positions relative to the antenna for different orientations of the handheld user device 204. Each row of the table is associated with an antenna and includes the grip drop in power for portrait orientation or landscape orientation. For example, table 255 may indicate that the received signal on antenna 220-A may be subject to a power drop of PGD 1 dB due to the user grip when the device is held in portrait orientation 230. Similarly, table 255 may indicate that the received signal on antenna 220-A may be subject to a power drop of LGD 1 dB due to the user grip when the device is held in landscape orientation 240. Table 255 may be configured, e.g., at the time of manufacturing through tests and measurements.

In some embodiments, process 250 may determine the orientation of handheld user device 204. Using table 255, process 250 may identify and select the antenna with the least power drop, e.g., grip drop, for locating the findable device.

In other embodiments, handheld user device 204 may determine a grip drop of an antenna based on measuring the strength of the received signals of the findable device on that antenna. Handheld user device 204, e.g., process 250, may select the antenna having the highest received signal strength or the smallest grip drop.

In some embodiments, process 250 may select more than one antenna to locate the findable device. Process 250 may filter the received signals on selected antennas or combine them and use the filtered or combined signals to locate the findable device.

Measurement results 260 shows the power attenuation due to mismatch between the antennas of the handheld user device 204 and the findable device 208. For example, when both handheld user device 204 device and findable device 208 are in vertical position (the right most figure in measurement results 260) there is a__40 decibel milliwatts (dBm). In some instances, measurement results 260 may be measured at the time of manufacturing or calibrating the handheld user device 204 and they may be stored or configured on the device.

### Process

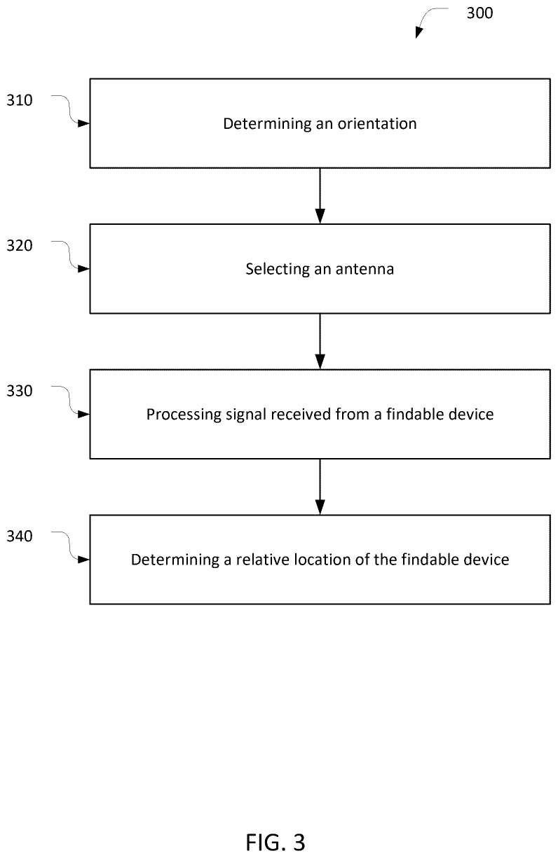

FIGS. 3, 6, 12, 14, 18, 19, and 20 illustrate example flow diagrams showing processes 300, 600, 1200, 1400, 1800, 1900, and 2000 according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

FIG. 3 illustrates a flow diagram depicting process 300 in accordance with some embodiments. Process 300 may be performed or implemented by a handheld user device, such as the handheld user device 104, or components thereof, such as process 140 or controller 2100.

Process 300 may include, at 310, determining the orientation of a handheld user device. The handheld user device may include a plurality of antennas. A process running in a handheld user device may use accelerometer, gyroscope, or magnetometer information to determine the orientation of the handheld user device.

Process 300 may include, at 320, selecting an antenna from among the plurality of antennas based at least in part on the orientation. The handheld user device may use a configured lookup table and the orientation of the handheld user device to select the antenna.

The handheld user device may determine a received signal strength indicator (RSSI) for each of the plurality of its antennas. The handheld user device may select the antenna with the largest RSSI.

Process 300 may include, at 330, processing signals the antenna receives from the findable device. For example, the handheld user device may obtain RSSIs of the received signals.

Process 300 may include, at 340, determining a relative location of the findable device with respect to the location of the handheld user device based on the signals received from the findable device. For example, the handheld user device may use ranging or localization procedures to locate the findable device.

In some embodiments, the handheld user device may generate a prompt to indicate to the user that they should adjust the orientation of the device. The prompt may be displayed on the handheld user device's screen using the user interface. The handheld user device, e.g., the process, may detect an adjustment in the orientation and select antennas to find the findable device accordingly.

In some embodiments, the handheld user device may generate a prompt to indicate to the user that they should adjust the grip of the device. The prompt may be displayed on the handheld user device's screen using the user interface. The handheld user device, e.g., the process, may detect an adjustment in the grip and select antennas to find the findable device accordingly.

### Selection with Rssi

The handheld user device, e.g., the process running on the handheld user device, may select the antennas used to find the findable device based on the RSSI. The handheld user device may select antennas whose received signals meet some conditions.

### RSSI Signal Diagram

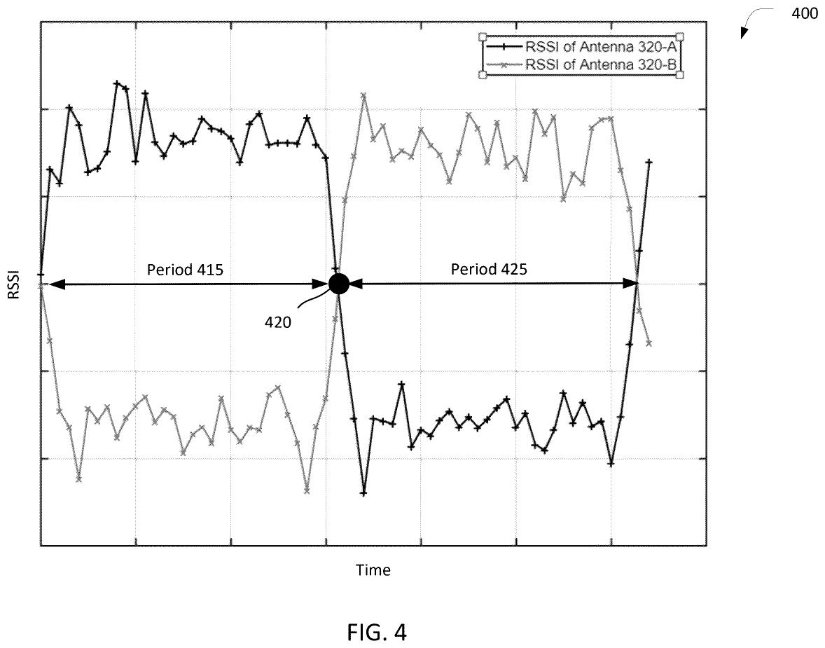

FIG. 4 illustrates signal diagram 400 in accordance with some embodiments. Signal diagram 400 depicts the RSSI of antennas 320-A and 320-B over time. Antenna 320-A may be an example of antenna 120-A or 220-A. Antenna 320-B may be an example of antenna 120-B or 220-B.

In some embodiments, the handheld user device may compare the RSSI of each antenna against a configured threshold. The handheld user device may select an antenna if the RSSI of the received signal on that antenna is greater than the threshold.

In some embodiments, the handheld user device may compare the RSSI of received signals on each of the antennas against each other. The handheld user device may select the antenna with the greatest RSSI value. For example, during period 415, the RSSI of antenna 320-A is greater than the RSSI of antenna 320-B, and the handheld user device may select and use antenna 320-A to locate the findable device. At 420, the RSSI of antenna 320-A may be equal to the RSSI of antenna 320-B. The handheld user device may keep using antenna 320-B, may use both antennas 320-A and 320-B, or may switch to antenna 320-B. During period 425, the RSSI of antenna 320-B is greater than the RSSI of antenna 320-A, and the handheld user device may select and use antenna 320-B to locate the findable device.

In some instances, the change in RSSI may indicate a change in orientation. In some instances, the change in RSSI may indicate that the corresponding antenna is obscured, e.g., due to the user's grip. For example, at 420, the RSSI of antenna 320-A drops. The handheld user device may determine that the drop in RSSI of antenna 320-A is due to antenna 320-A being obscured, e.g., by the user's hand, or the drop is due to a change in orientation of the handheld user device.

The findable device may send one or more beacons. The handheld user device may receive and measure the received energy of the beacon. For example, the handheld user device may sample the received signal over time and compute the samples' average energy. The receiver can only measure the RSSI and, in some instances, may not be able to measure the distance directly. However, the receiver, e.g., the handheld user device, may measure and identify trends in the RSSI measurements, e.g., RSSI increasing or decreasing, depending on the direction of the movement of the device. An increase in RSSI may indicate getting closer to the findable device, whereas a decrease in RSSI may indicate moving away from the findable device.

The environment may influence RSSI measurement. In some instances, even if the accessory and the handheld user device do not move, the measured RSSI may still fluctuate. Some fluctuations are due to stationary and slow-moving conditions of the wireless channel between the findable device and the handheld user device. Such fluctuations may be referred to as slow fading. Some fluctuations may be due to constant and rapid environmental changes, e.g., trees, moving leaves, and moving objects such as people, cars, etc. These fluctuations may be referred to as fast fading. As discussed above, the RSSI may also be influenced by grip or by being covered with other objects or the human body.

RSSI measurement may be influenced by the size of the device and its form factor. Different features, e.g., supporting WiFi or Cellular, may impact the RSSI measurements even in one form factor. The variance of the RSSI measurements at different orientations may determine the sensitivity of the measurements with respect to the orientation. In some instances, the RSSI measurement of smaller devices may be more sensitive to variations in orientation.

### Antenna Pattern

An antenna may be associated with an antenna pattern. The antenna pattern may indicate the amount of amplification or attenuation as a function of the direction of propagation of the received signal. In some directions, the received signal may be subject to amplification, and in some directions, e.g., in null directions, the antenna may receive no or very little energy of the signal. Therefore, in some instances, the drop in received power may be associated with the antenna pattern.

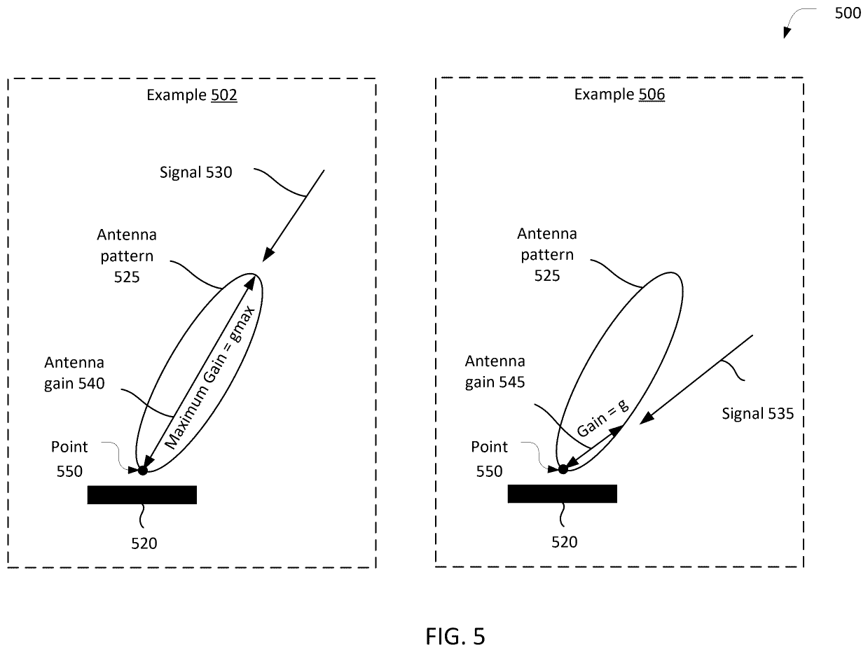

FIG. 5 illustrates examples 500 of the impact of antenna patterns on received signals in accordance with some embodiments. Example 502 depicts antenna pattern 525 of antenna 520. Antenna 520 may be an example of antennas 120-A/B/C or 220-A/B/C. In some instances, the length of the line segment connecting point 550 to a point on the antenna pattern 525 represents, e.g., is proportionate to the gain or attenuation of a signal that is received (or transmitted) with a propagation direction that is colinear with that line segment. For example, in example 502, signal 530 is received collinear to the direction of the antenna gain 540, e.g., the maximum gain of gₘₐₓ, and therefore, the received signal is subject to the maximum gain of antenna 520. In some instances, the antenna pattern is normalized based on the maximum gain, such that gₘₐₓ=1. The antenna does not amplify, and the maximum received power is the signal's received power.

Similarly, in example 506, signal 535 is received in the direction collinear with antenna gain 545, gain=g. In a normalized antenna pattern, any gain, g, is smaller than or equal to 1. In example 506, the received signal is attenuated by a factor of g.

In some embodiments, the antenna pattern of antennas of a handheld user device may be stored in the handheld user device. For example, during the device's manufacturing, the antenna pattern of each antenna under different conditions may be measured and stored in the handheld user device. For example, the antenna pattern may be measured in free space, or it may be measured while a user is holding the device with different orientations.

The handheld user device may determine whether the antenna is obscured based on the measurements and the antenna pattern. For example, if the power drop is due to the antenna pattern, the handheld user device may not determine that the antenna is obscured.

In some instances, the antenna pattern of antennas of a radio access network may differ from that of another radio access network. For example, the antenna pattern of WiFi may be different from the antenna pattern of Bluetooth. Considering the difference in antenna patterns between antennas of different radio access technologies in determining the location of the findable device may provide a consistent performance and user experience.

In some embodiments, the location of antennas and the existence of antennas of other radio access technologies may impact the antenna patterns. For example, the antenna patterns of a given radio technology, e.g., WiFi, may be different in different form factors or SKUs. Also, whether the handheld user device includes antennas of another radio technology, such as Bluetooth or cellular, may impact the antenna patterns of WiFi antennas. Measuring the antenna pattern of antennas in the final form factor or SKU may provide consistent performance and user experience across different form factors or SKUs.

### Process

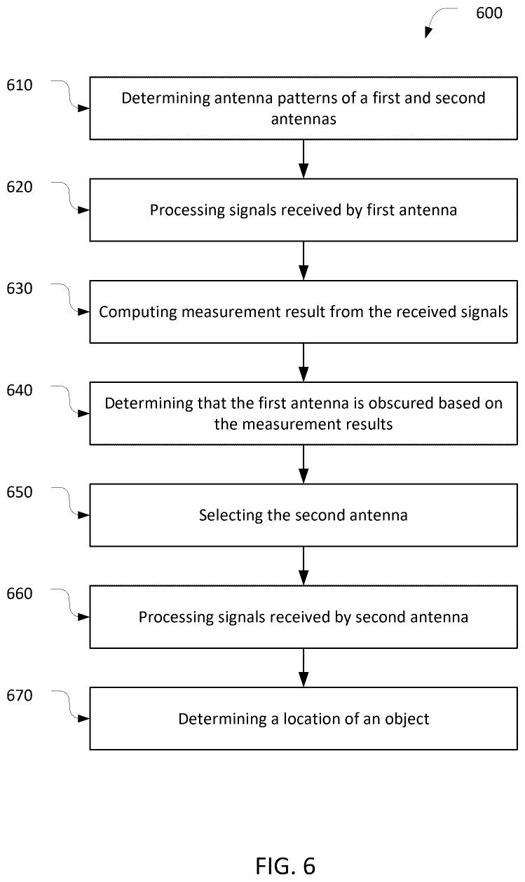

FIG. 6 illustrates a flow diagram depicting process 600 in accordance with some embodiments. Process 600 may be performed or implemented by a handheld user device, such as the handheld user device 104, or components thereof, such as process 140 or controller 2100.

Process 600 may include, at 610, determining an antenna pattern of a first antenna of a handheld user device. The handheld user device has a plurality of antennas. The antenna pattern may be measured and stored in the device, e.g., during manufacturing, calibration, or testing. The antenna pattern may indicate how the antenna radiates or receives signal energy.

For example, to measure the antenna pattern, the antenna may be placed in a controlled environment. A fixed antenna is placed at a location. The antenna is repositioned at various angles using a positioner controller. If the antenna is transmitting, the fixed antenna receives the signals. If the antenna is receiving, it may pick up the signal transmitted by the fixed antenna. At each position, the signal received by the fixed antenna or the antenna is corded. This signal is correlated to its angle of arrival. The resulting antenna pattern may be stored in the device.

Process 600 may include, at 620, processing first signals received by the first antenna to obtain one or more measurements. First signals may be transmitted by the findable device and may include one or more signals received by the first antenna. One or more measurements may include measuring the received signal energy, strength, or power.

Process 600 may include, at 630, computing a measurement result based on one or more measurements. The measurement result may include filtering, e.g., averaging, or combining the measurement with measurements of other antennas. For example, the one or more measurements may include one or more measured RSSIs. Process 300 may filter the one or more measured RSSI to obtain an RSSI result. The filtering may be a low-pass filtering that averages one or more RSSIs based on the length of the filter. The filter may be designed to calculate a weighted average of the one or more RSSIs.

An RSSI value may represent the signal strength measured in a time interval or while the handheld user device moves a certain distance. In one example, the one or more RSSI measurements are obtained in a configured period, e.g., time-based filtering or averaging. In another example, the RSSI measurements are obtained while the handheld user device moves a configured distance, e.g., distance-based filtering or averaging.

Process 600 may include, at 640, determining that the first antenna is obscured based on the measurement result and the antenna pattern of the first antenna. For example, the signals transmitted by the findable device may be known signals with known transmit power. Based on the pathloss estimate and received power, process 600 may estimate the range or distance of the findable device to the handheld user device.

In some instances, e.g., ultra wideband (UWB) systems, the range or distance between the findable device and the handheld user device can be calculated using the round trip time. The handheld user device may send a signal at time U₁. Upon receiving the signal by the findable device, the findable device may send a signal back to the handheld user device, which may be received by the handheld user device at time U₂. The handheld user device may calculate the range using the round trip time (U₂-U₁) and the speed of light, c, e.g., Range=0.5·(U₂−U₁)·c.

Based on the estimated location of the findable device and the receiving antenna pattern, process 600 may calculate an average expected received power. If the received power is notably smaller than expected, process 600 may determine that the antenna is obscured and that the additional drop is caused by the user's hand or grip.

Process 600 may include, at 650, selecting a second antenna from among the plurality of antennas. The second antenna may be selected based on the received RSSI on that antenna. In some instances, the antenna pattern of the second antenna may be considered in its selection. For example, process 600 may use an estimate of the location of the findable device and the antenna pattern of all antennas of handheld user devices to estimate the RSSI of each antenna. Process 600 may select the antenna with the largest RSSI. In another example, the handheld user device may measure the RSSI on all antennas, and process 600 may select the antenna with the largest RSSI value.

In some embodiments, the handheld user device may select more than one antenna. For example, the K antennas with the K largest RSSI values may be selected. Process 600 may combine the RSSI of the selected antenna and use the combined RSSI to locate the findable device.

The process 600 may include, at 660, processing second signals received from the second antenna. For example, the handheld user device may compute the RSSI associated with the received signals or the angle of arrival of the second signal. In some examples, processing a signal may include the process and procedures associated with receiving the signal.

The process 600 may include, at 670, determining the relative location of a findable device with respect to the location of the handheld user device based on the second signals. For example, the handheld user device may use the RSSI, antenna pattern, angle of arrival, or other parameters or measurements to determine the location of the findable device with respect to the location of the handheld user device.

### Antenna Pattern

The antenna pattern may impact the accuracy of locating the findable device. As the user moves around with the handheld user device in search of the findable device, the received signal from the findable device may be received through different gains or attenuations of the antenna pattern. It is desirable to take into consideration the impact of the antenna pattern in locating the findable device.

### Impact of Antenna Pattern and Orientation on RSSI

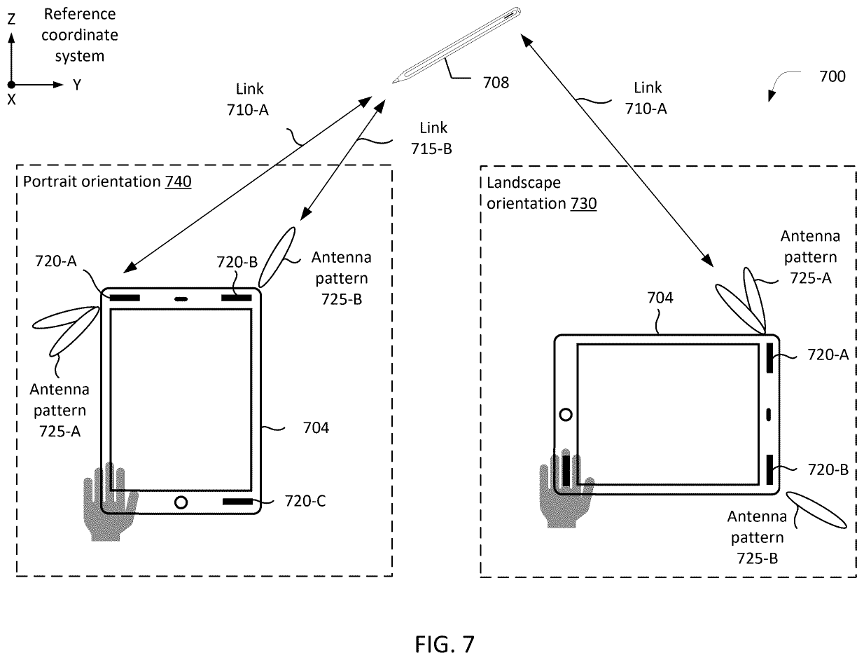

FIG. 7 illustrates examples of orientation and antenna patterns 700 in accordance with some embodiments. The illustrated patterns, e.g., antenna patterns 725-A and B, are just examples of antenna patterns, and the antenna patterns may be different for different antennas and may take different shapes. Consider that the handheld user device 704 was initially in landscape orientation at 730. Handheld user device 704 may be an example of handheld user device 104 or 204. Handheld user device 704 may include antennas 720-A and 720-B. Antenna 720-A may be associated with antenna pattern 725-A, and antenna 720-B may be associated with antenna pattern 725-B. Handheld user device 704 may be communicatively coupled with findable device 708. Findable device 708 may be an example of findable device 108.

When in landscape orientation 730, the propagation direction of the signal from findable device 708 may be colinear with a non-zero antenna gain of the antenna pattern. In some instances, the received signal in the direction with antenna gain larger than a threshold, e.g., 0.5 (half power beam width), is considered. For example, the signal on link 710-A may be received by antenna 720-A subject to the antenna pattern 725-A. However, findable device 708 may be in the null space of the antenna pattern 725-B of antenna 720-B. Therefore, handheld user device 704 may not receive a signal from findable device 708 on antenna 720-B.

When in portrait orientation 740, the signal on link 715-B may be received by antenna 720-B subject to the antenna pattern 725-B. However, the signal on link 710-A may fall into a null space of antenna pattern 725-A and no longer be received by antenna 720-A. To continue locating the findable device 708, handheld user device 704 may switch antenna and use signals received on antenna 720-B to locate findable device 708.

Handheld user devices may use a reference coordinate system to locate the findable device 708. In some instances, the origin of the reference coordinate system may be the location of handheld user device 704. When the origin of the reference coordinate system is the location of handheld user device 704, the location of any point, including the location of findable device 708, is relative to the location of handheld user device 704.

### RSSI Signal Diagram Subject to Antenna Pattern

When finding a findable device, the user may move the handheld user device. For example, while holding the handheld user device, the user may rotate the handheld user device and change its orientation. The user may turn around in a given location and receive feedback on the screen to identify the direction with a larger received signal strength or the direction of the findable device. The user may also move around the environment to allow the handheld user device to perform measurements and estimate the location of the findable device.

The movement of the device, whether angular or linear displacement, may change the antenna gain of the received signal, e.g., due to antenna pattern. In addition, the received signal may be subject to fast fading or slow fading caused by positive or negative superposition of signals reflected signals at the receiver. Angular rotation is an example of angular displacement.

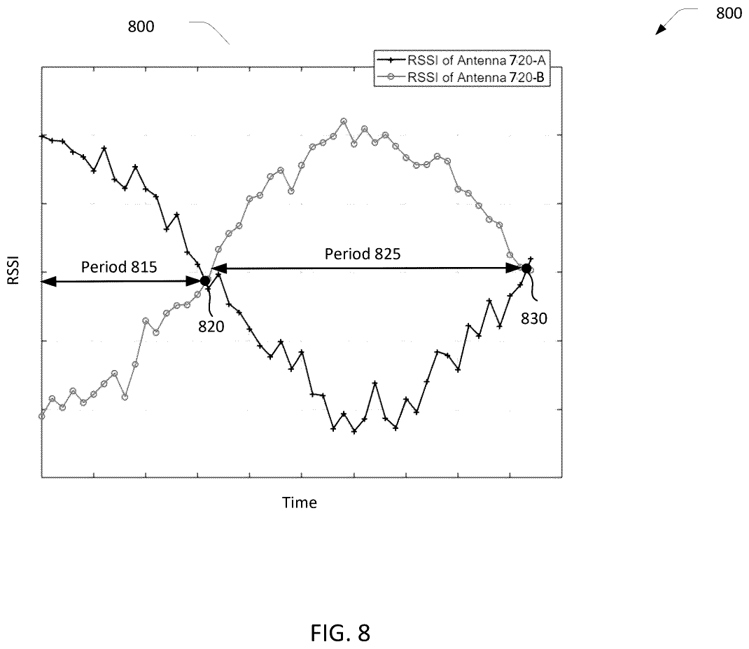

FIG. 8 illustrates signal diagram 800 in accordance with some embodiments. The dark trace with the “+” marker depicts the RSSI of antenna 720-A and the gray trace with the “o” marker depicts the RSSI of antenna 720-B. The fluctuation of RSSI signals may be caused by the device's movement, subjecting the received signal to fading and antenna gain variation.

During period 815, the RSSI of antenna 720-A is larger than the RSSI of antenna 720-B. At 820, the RSSI of both antennas 720-A/B may be equal or substantially the same. During the period 825, the RSSI of antenna 720-B was larger than the RSSI of antenna 720-A. At 830, the RSSI of both antennas 720-A/B may again be equal or substantially the same. In some instances, periods 815 or 825 may be very short compared to the handheld user device movement rate, e.g., the RSSIs may crossover one or more times while the handheld user device is in a given location. In other examples, periods 815 or 825 may last while the user device is moved a given distance, e.g., rotate for some degrees or linearly displaced by some distance.

In one example, the RSSIs may crossover one or more times while the handheld user device is in a given location. This may happen when the average received power on antennas 720-A and 720-B are similar but experience different fading. The fading may cause random fluctuation in the received power, causing the RSSI plots to crossover one or more times. Fading is an effect that occurs when two or more signal reflections constructively and destructively interfere with each other. As the phase difference of arrival of a pair of signals goes from 0->180 degrees, it goes from constructive to destructive interference. The wavelength of the signal and the geometries that affect reflections are also important. The size of spatial averaging can be a function of the wavelength and an estimated distance, which may imply the sizes of geometries that are interacting.

A two-ray model may model the received signal. The two-ray model, or the ground-reflection model, is a multipath radio propagation model. The model may consider the direct, e.g., line of sight (LOS) path and a ground-reflected path between the transmitter and receiver. Depending on the phase difference between the LOS ray and the reflected ray, the received signal may suffer constructive or destructive interference. The received power in the two-ray model may be affected by the distance, frequency, and antenna height relative to the reflective surface.

Whether the direct and reflected rays interfere with each other constructively or destructively depends on the phase of the two signals at the receiver. When the two signals received at the receiver have the same phase, they may interfere constructively. However, if the signals are at opposite phases with respect to one another, the signals may interfere destructively.

When the receiver is at a close distance to the transmitter, a small change of location may cause a significant phase change. Therefore, when the receiver is near the transmitter, a small movement of the transmitter or receiver may change a constructive interference to a destructive one.

However, when the transmitter and receiver are far away from each other, a small movement of the transmitter or receiver may not cause a large phase difference between the direct and reflected rays. Therefore, if the receiver is in a deep fade, e.g., the direct ray and the reflected ray are at almost opposite phases, e.g., 180 degrees phase difference, the receiver may have to move a longer distance (as opposed to the case when transmitter and receiver are near each other) in order to come out of a deep fade. Moving a longer distance may be equivalent to taking a longer time. Therefore, when the user is moving and the handheld user device is far away from the findable device, it may take a longer time for the handheld user device to come out of a deep fade as opposed to when the handheld user device is near the findable device.

Average RSSI may be obtained by averaging several measured RSSIs. Average RSSI may be obtained to reduce the impact of fading on the measured RSSI. If the average RSSI is obtained by averaging RSSIs measured in a fixed period, and the handheld user device is far from the findable device, all the measured RSSIs may be obtained while the handheld user device is in a deep fade. Averaging these RSSIs may not reduce the impact of fading on average RSSI. However, if instead of averaging measured RSSIs in a fixed period, the RSSIs measured while the handheld user device has moved a certain distance, and the distance is large enough to take the handheld user device out of a deep fade, then the averaged RSSI may reduce the impact of fading.

### Likelihood-based Directionality Estimation

As the user moves in the environment, the handheld user device may receive more and more signals from the findable device. The received signals may be received from different directions, being subject to different antenna gains of the antenna pattern and traveling different distances to reach the handheld user device. The handheld user device may use the accumulation of information as it receives signals from the findable device to refine its estimate of the location of the findable device.

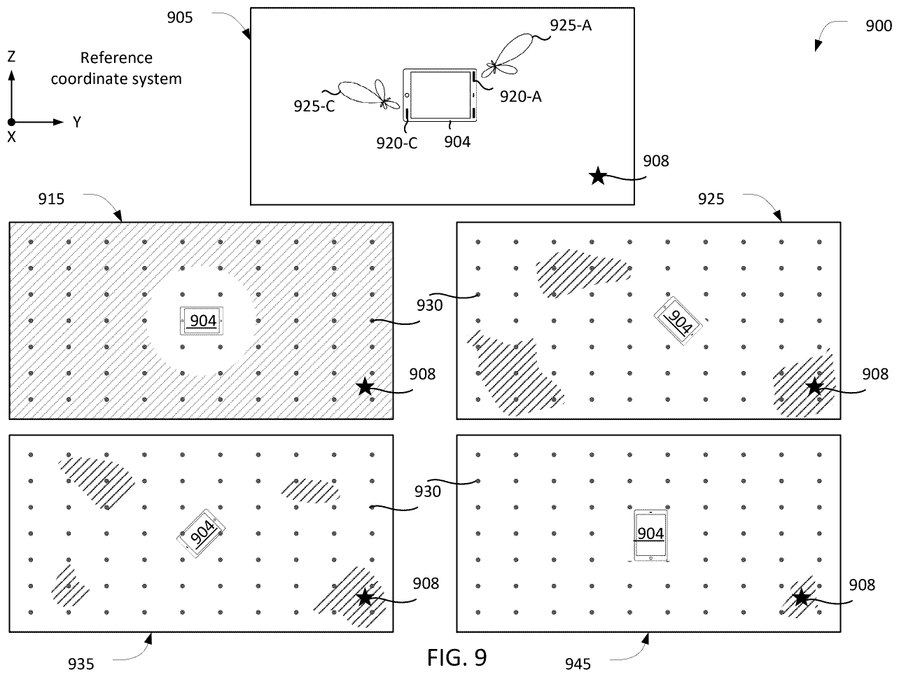

FIG. 9 illustrates an example of likelihood-based finding process 900 in accordance with some embodiments. Environment 905 may include a handheld user device 904. Handheld user device 904 may be an example of handheld user device 104, 204, or 704. The environment 905 may also include a findable device 908. Findable device 908 may be an example of findable device 108 or 708. Handheld user device 904 may include antennas 920-A/C. Antennas 920-A/C may be examples of antennas 120-A/C, 220-A/C, or 720-A/C.

At 915, handheld user device 904 may initiate the finding process to locate findable device 908. Handheld user device 904 may be at a first location, at a first time instance, t1. The process, e.g., the finding application or daemon, may identify a grid 930 of points in the environment 905. Handheld user device 904, e.g., the process running on the handheld user device 904, may evaluate the likelihood of findable device 908 being at each point of grid 930. At 915, handheld user device 904 may not have received enough signals from findable device 908. Therefore, the findable device 908 may have a similar likelihood of being in the majority of points in grid 930. The hashed area at 915 indicates the area identified by handheld user device 904, where findable device 908 is likely to be located. The un-hashed area around handheld user device 904 may indicate where findable device 908 is unlikely to be located.

In one example, the likelihood of findable device 908 being at each point of grid 930 may be calculated using hypothesis testing and associated methods and techniques. For example, at each point, two hypotheses may be considered: a null hypothesis and an alternate hypothesis. The null hypothesis may be the assumption that the findable device is not located at the point. The null hypothesis may be denoted by H0. The alternate hypothesis may be the logical opposite of the null hypothesis, e.g., the assumption that the findable device is located at the point. The alternate hypothesis may be denoted by H1. Based on the distribution of noise, fading channel, position of the handheld user device, and the measurements based on the received signals, the handheld user device may perform different hypothesis tests. The handheld user device may determine a probability or likelihood associated with each of the hypotheses, H0 or H1. In one example, the handheld user device may determine the log-likelihood ratio, e.g., Log (Pr(H₁)/Pr(H₀)), where Pr(H₁) is a probability associated with the alternate hypothesis, H₁, and Pr(H₀) is a probability associated with the null hypothesis, H₀. The ratio Pr(H₁)/Pr(H₀) may be referred to as the likelihood ratio, and Log ( ) is a logarithmic function.

If the likelihood or probability of a findable device at a location is larger than a threshold, it may be marked and displayed on the user interface.

At 925, handheld user device 904 may be at a second location, at a second time instance, t2. Handheld user device 904 may have moved from the first location to the second location, e.g., via an angular displacement, a linear displacement, or both.

Handheld user device 904 may have received additional signals from findable device 908. By using the received signals and/or information on antenna patterns, handheld user device 904 may refine and update the likelihood of the presence of findable device 908 at each point of grid 930. The hashed area at the 925 snapshot indicates the areas where findable device 908 is likely to be located. For example, handheld user device 904 may repeat the calculation of the likelihood of findable device 908 being at each point of the grid 930. Areas with a likelihood greater than a threshold may be marked on the user interface as candidate locations for findable device 908.

At 935, handheld user device 904 may be at a third location, at a third time instance, t3. Handheld user device 904 may have moved from the second location to the third location, e.g., via an angular displacement, a linear displacement, or both.

Handheld user device 904 may have received additional signals from findable device 908. By using the received signals or information of antenna patterns, handheld user device 904 may refine and update the likelihood of the presence of findable device 908 at each point of grid 930. The hashed area at the 935 snapshot indicates the areas where findable device 908 is likely to be located. The update may identify points in grid 930 that are likely for findable device 908 to be located, which were previously identified as unlikely.

At 945, handheld user device 904 may be at a fourth location, at a fourth time instance, t4. Handheld user device 904 may have moved from the third location to the fourth location, e.g., via an angular displacement, a linear displacement, or both.

Handheld user device 904 may have received additional signals from findable device 908. By using the received signals or information of antenna patterns, handheld user device 904 may refine and update the likelihood of the presence of findable device 908 at each point of grid 930. At 945, handheld user device 904 may identify the location of findable device 908.

The reevaluation of the likelihood of the presence of findable device 908 at each point of grid 930 may use the signals received on one or more handheld user device 904 antennas.

In some instances, the process may not provide the exact location of findable device 908. However, the likelihood may be small enough that handheld user device 904 provides textual or graphical prompts to the user via the user interface. For example, the user interface may display an arrow or an arc in the direction of findable device 908.

### Filtering and Combining

To estimate the location of the findable device, the handheld user device may use the received signal on more than one antenna. In some embodiments, the handheld user device may select signals on one antenna over others, e.g., based on signal strength or quality. In some embodiments, the handheld user device may filter or combine the signals from several antennas, e.g., apply techniques such as coherent combining, maximum ration combining, or weighted averaging.

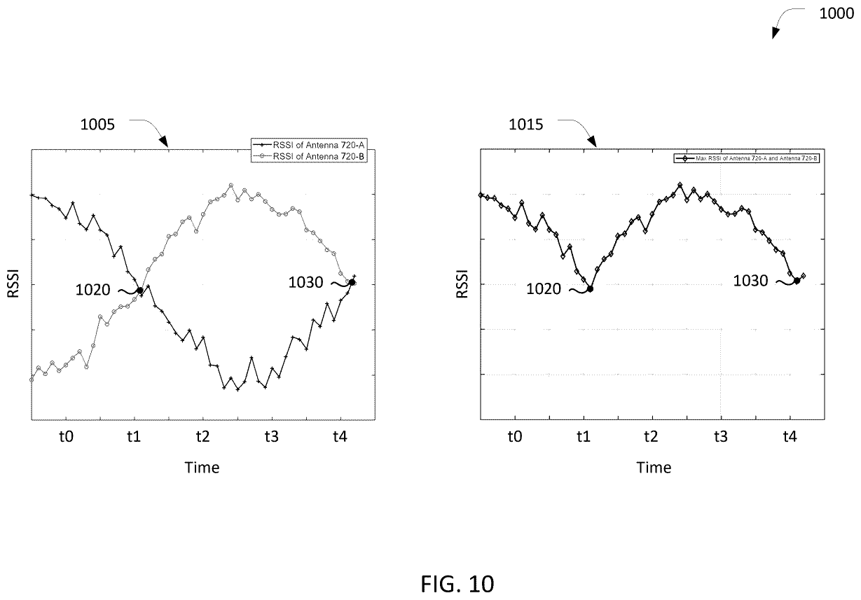

FIG. 10 illustrates signal diagram 1000 in accordance with some embodiments. Diagram 1005 may illustrate the RSSI of antennas 720-A/B. The dark trace with the “+” marker depicts the RSSI of antenna 720-A and the gray trace with the “o” marker depicts the RSSI of antenna 720-B. The fluctuation of RSSI signals may be caused by the device's movement, subjecting the received signal to fading and antenna gain variation.

During the period between t0 and t1, the RSSI of antenna 720-A is larger than the RSSI of antenna 720-B. At 1020, the RSSI of both antennas 720-A/B may be equal or substantially the same. During the period between 1020 and 1030, e.g., t2−t4, the RSSI of antenna 720-B was larger than the RSSI of antenna 720-A. At 1030, the RSSI of both antennas 720-A/B may again be equal or substantially the same.

In some embodiments, at 1020, the handheld user device may switch the antenna and select antenna 720-B for measurement. In some embodiments, handheld user devices may use the signals from both antennas 720-A/B. For example, diagram 1015 illustrates filtering signals received on antennas 720-A and B. Diagram 1015 is an example of applying a “max” function on RSSI of both antennas 720-A and B where the “max” function returns the maximum value of RSSI received on antennas 720-A and B.

In a maximum ratio combining, the received signal P1 on antenna 720-A may be normalized with antenna gain, G1, of antenna 720-A based on the antenna pattern 725-A of antenna 720-A. Similarly, the received signal P2 on antenna 720-B may be normalized with antenna gain, G2, of antenna 720-B based on the antenna pattern 725-B of antenna 720-B. The normalized signals may be combined, e.g., P1/G1+P2/G2. In other examples, the signals S1 and S2 may be averaged, e.g., P1+P2, or a weighted averaging in the form of a1·P1+a2·P2 is applied. Where weights a1 and a2 satisfying, 0<a1, a2, and a1+a2=1. The resultant filtered or combined signal may be used to locate the findable device.

### Time-based and Location-based RSSI Filtering

The finding process may receive one or more RSSI measurements from the handheld user device and filter them to obtain a measurement result that is used for locating the findable device. In one example, the process may receive one or more RSSI measurements associated with a channel and use the filtering output result to locate the findable device. A channel may be a receiving antenna, a communication channel, or a band. For example, Bluetooth or WiFi communication may include one or more channels.

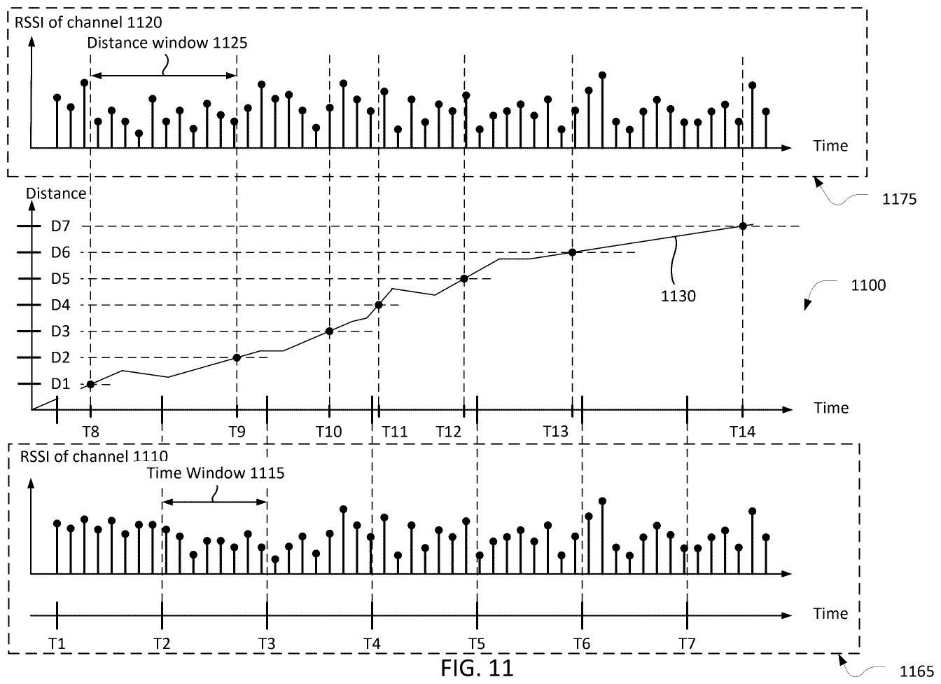

FIG. 11 illustrates signal diagram 1100 in accordance with some embodiments. Diagram 1100 includes time-based filtering 1165 and location-based filtering 1175.

In time-based filtering 1165, the time may be divided into equal-length time windows, e.g., time window 1115. For example, time intervals T1-T2, T2-T3, T3-T4, T4-T5, T5-T6, and T6-T7 may have the same duration as time window 1115.

The handheld user device may filter the RSSI measurements obtained during the time window, e.g., time window 1115, on channel 1110, to obtain one or more measurement results. The measurement results may be an average RSSI value of RSSI measures of channel 1110. The handheld user device may use one or more measurement results to locate the findable device.

Diagram 1130 is an example of the displacement (distance traveled) of the handheld user device in time. For example, between time 0 and T8, the handheld has a displacement of D1. At T9, the handheld user device has made a total displacement of D2, and similarly, at T10, a total displacement of D3, at T11, a total displacement of D4, at T12, a total displacement of D5, at T13, a total displacement of D6, and a total displacement of D7 at T14. In one example, a distance window 1125 may be defined when the handheld displacement is equal to a configured value. The value may be a linear displacement, e.g., 0.5 meter (m), 1 m, or 2 m. The value may be an angular displacement, e.g., 10 degrees, 20 degrees, 30 degrees, or 45 degrees.

For example, in diagram 1130, assuming that the D2-D1, D3-D2, D4-D3, D5-D4, D6-D5, and D7-D6 are the same displacement, D, then the distances windows would be T8-T9, T9-T10, T10-T11, T11-T12, T12-T13, and T13-T14. Note that (−) is a subtraction, and (-) is used to indicate a range. For example (T2−T1) is the difference between T2 and T1, and T1-T2 indicates the range or period between T1 and T2.

The handheld user device may filter the RSSI measurements obtained during the distance windows, e.g., distance window 1125, on channel 1120, to obtain one or more measurement results. The measurement results may be an average RSSI value of RSSI measurements of channel 1120. The handheld user device may use one or more measurement results to locate the findable device.

### Process

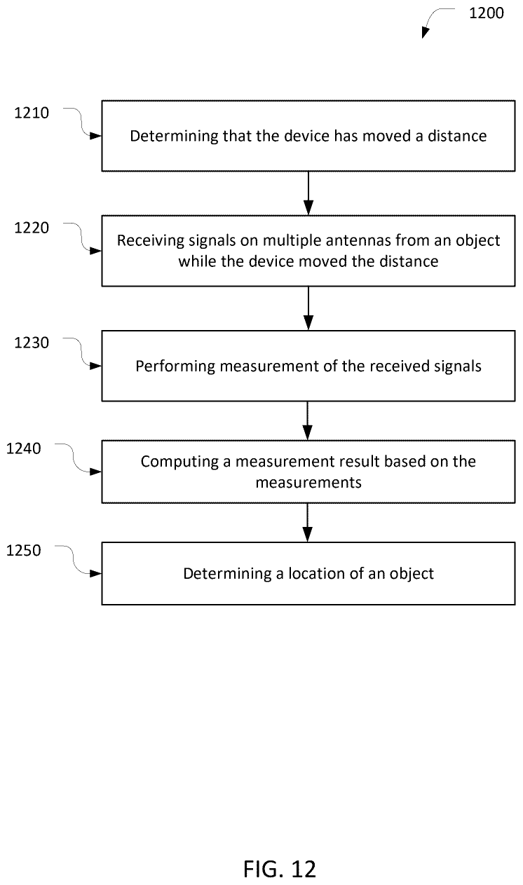

FIG. 12 illustrates a flow diagram depicting process 1200 in accordance with some embodiments. Process 1200 may be performed or implemented by a handheld user device, such as the handheld user device 104, or components thereof, such as process 140 or controller 2100.

Process 1200 may include, at 1210, determining that the handheld user device has moved a distance. The distance may be a linear displacement or an angular displacement. The distance may be a configured value, e.g., 1 m of linear displacement or 45 degrees of angular displacement.

Process 1200 may include, at 1220, receiving signals from a findable device on a plurality of channels while the handheld user device moves the distance. The channels may be communication channels, e.g., Bluetooth channels. In other examples, each channel may be associated with an antenna of the handheld user device.

Process 1200 may include, at 1230, performing measurements of the signals. For example, the handheld user device may measure the RSSI of signals received on each channel.

Process 1200 may include, at 1240, computing a measurement result for each channel of the plurality of channels based on the measurements. The handheld user device may filter the measurement of the signals. For example, the handheld user device may perform time- or location-based filtering on the measurements to obtain one or more measurement results.

In some embodiment, the handheld user device may select a channel of the plurality of channels based on the measurement results. For example, the handheld user device may select an antenna based on the measurement result.

Process 1200 may include, at 1250, determining a relative location of the findable device with respect to the location of the handheld user device based on the measurement result.

### Pattern Matching

The handheld user device may use information such as a prediction or estimation of received power of signals from the findable device, one or more measurements at different times or locations, and the antenna pattern of the receiving antenna to estimate the location of the findable device.

### DESCRIPTION

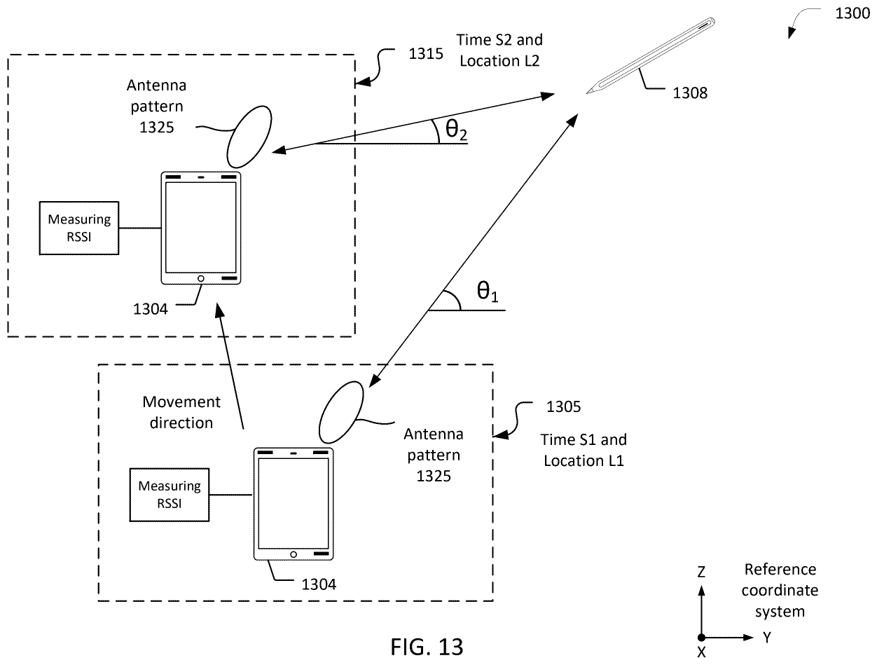

FIG. 13 illustrates an example of a finding process 1300 in accordance with some embodiments. Finding process 1300 may include a handheld user device 1304. Handheld user device 1304 may be an example of handheld user devices 104, 204, 704, or 904. Finding process 1300 may also include a findable device 1308. Findable device 1308 may be an example of findable devices 108, 708, or 908.

At 1305, handheld user device 1304 may be at location L1 at time S1. Handheld user device 1304 may receive signals from findable device 1308. The received signal may be subject to antenna pattern 1325. Handheld user device 1304 may measure the RSSI of the received signals and filter one or more measurements to obtain a measurement result.

Handheld user device 1304 may move in the illustrated movement direction. At 1315, handheld user device 1304 may be at location L2 at time S2. Handheld user device 1304 may continue receiving signals from findable device 1308. The received signal may be subject to antenna pattern 1325. However, due to the movement, the received signal at 1315 may be subject to a different antenna gain of the antenna pattern 1325 than that at 1305. For example, at location S1, the direction of signal from findable device 1308 may align with antenna pattern 1325 direction having a gain, G1. Similarly, at location, S2, the direction of the signal from findable device 1308 may align with a different direction of antenna pattern 1325, which has a gain, G2. Gains G1 and G2 may be different. In some instances, at the same distance from findable device 1308, different rotations of the handheld user device 1304 may subject the received signal to different portions of the antenna pattern, which may result in signal fluctuation due to the antenna pattern.

Handheld user device 1304 may use the configured information of antenna pattern 1325, the measurements at 1305 and 1315, and the displacement between L1 and L2 to estimate the location of findable device 1308. For example, handheld user device 1304 may estimate the angle of arrival and distance of findable device 1308 that, when combined with the antenna pattern 1325, matches the measured RSSIs.

For example, given the received values of RSSI measured at different locations, e.g., locations L1 and L2, and configure or stored information of antenna pattern 1325, handheld user device 1304 may estimate the angle of arrival, θ₁ or θ₂, of the signals from findable device 1308 that could result in the measured RSSIs. Using the ranging techniques and having the angle of arrival, handheld user device 1304 may estimate the location of the stylus.

### Process

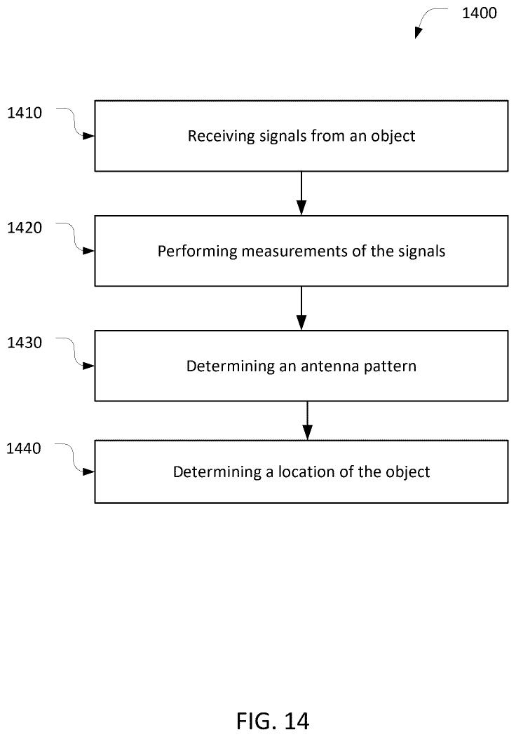

FIG. 14 illustrates a flow diagram depicting process 1400 in accordance with some embodiments. The process 1400 may be performed or implemented by a handheld user device, such as the handheld user device 104, or components thereof, such as process 140 or controller 2100.

Process 1400 may include, at 1410, receiving signals associated with a findable device at an antenna of a handheld user device.

Process 1400 may include, at 1420, performing measurements of the signal. For example, the RSSI of the signal may be measured.

Process 1400 may include, at 1430, determining an antenna pattern associated with the antenna of the handheld user device. The antenna pattern of the receiving antenna may be configured and stored on a handheld user device. The finding process running on the handheld user device may retrieve the stored antenna pattern information.

In some embodiments, the antenna pattern may be measured at the time of device manufacturing or calibration. The antenna pattern may be measured with a user holding the antenna or the device with the antenna. Alternatively or additionally, the antenna pattern may be measured with a user being next to the antenna and may or may not hold the antenna or the associated device, e.g., the handheld user device.

Process 1400 may include, at 1440, determining a relative location of the findable device with respect to the location of the handheld user device based on the measurement and the antenna pattern. The handheld user device may determine the location of the findable device by matching the measured RSSIs to the antenna pattern to obtain the angle of arrival of signals from the findable device.

In some embodiments, process 1400 may generate an estimated measurement. For example, the signal transmitted by the findable device may be a known signal having a known transmitted power. Based on the estimated distance between the handheld user device, the pathloss, the transmitted power, and the antenna pattern, process 1400 may calculate an estimated received power or RSSI. Process 1400 may generate a plurality of estimates, assuming the signal arrives at different angles and through different directions of the antenna pattern.

Process 1400 may compare the estimated RSSI with the measured RSSI and identify an estimate that matches the measurement. Process 1400 may determine the angle of arrival of the estimate that matches the measurement as the angle of arrival of the signal from the findable device. With an estimate of distance and angle of arrival, process 1400 may determine the location of the findable device.

In some embodiments, process 1400 may identify a grid of points in the environment. Process 1400 may evaluate the likelihood of a findable device being at each point of the grid. Process 1400 may identify the area where the findable device is likely to be located using the user interface.

The process 1400 may obtain additional measurements and update the likelihood of the findable device being at each point.

### User Interface

The handheld user device may use a user interface to communicate information related to finding the findable device with the user. The user interface may include textual or graphical information guiding the user to the location of the findable device.

### Description

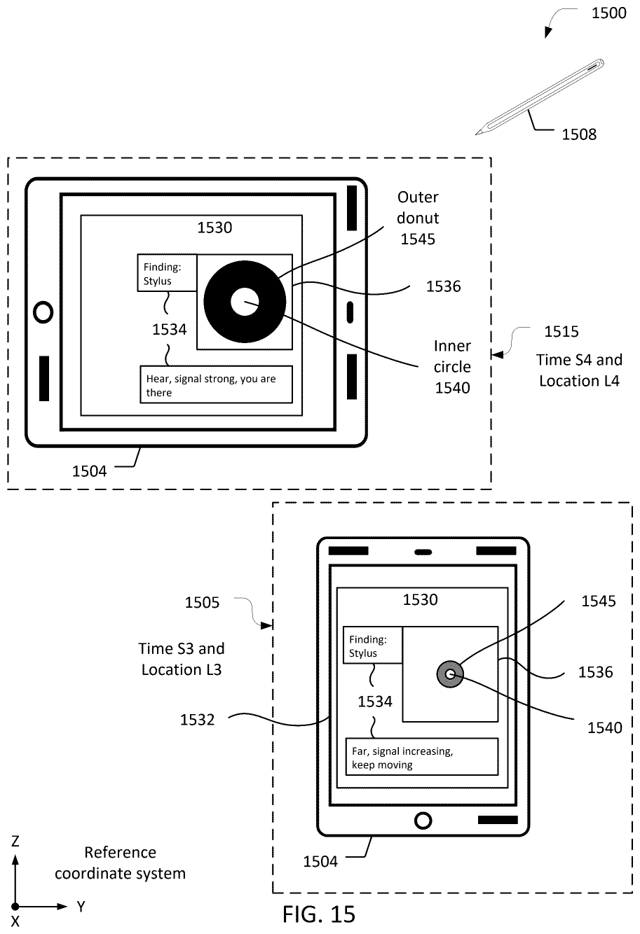

FIG. 15 illustrates examples of graphical interfaces 1500 in accordance with some embodiments. Handheld user device 1504 may be an example of user device 104 in FIG. 1. Handheld user device 1504 may include a screen 1532. Screen 1532 may be an example of screen 132 in FIG. 1. The finding process running on handheld user device 1504 may provide information about the finding process of findable device 1508 on user interface 1530. Findable device 1508 may be an example of findable device 108. Finding process may be an example of processes 300, 600, 1200, 1400, 1800, or 1900.

Finding application may provide a user interface 1530. User interface 1530 may include one or more textual portions 1534 and one or more graphical portions 1536. The textual portion may include findable device 1508 information, e.g., when locating a stylus, the textual portion 1534 may display the following message: “Finding: stylus.” One or more textual portion 1534 may display an indication of whether the findable device is near or far or guiding instructions such as the direction of movement.

The textual indication of distance may be coarse and discrete. For example, user interface 1530 may have three states, e.g., “hear,” “near,” or “far.” With graphical representation using the user interface elements, continuous guidance can be provided to the user. For example, a user interface element may be a bubble that grows as estimated RSSI increases, e.g., getting closer, or the bubble may shrink as estimated RSSI decreases, e.g., getting farther.

one or more graphical portions 1536 may include one or more user interface elements, e.g., an image. One image may indicate the received signal strength or distance to the findable device 108. One or more graphical portions 136 may include a user interface element, e.g., an image, to indicate the relative location of the findable device 108 or a direction of movement guiding the user toward the findable device 108.

As the user moves toward the findable device 1508 with handheld user device 1504, the finding process may continue receiving and analyzing signals from findable device 1508. The finding process may recalculate the relative location of findable device 1508 with respect to the location of handheld user device 1504 and update the information continuously displayed on user interface 1530.

In one example, at 1505, handheld user device 1504 may be in portrait orientation and located at L3 at time S3. The user interface elements, e.g., graphical images, may include a circle 1540 and a donut 1545. The radius of the circle 1540 or the thickness of the donut 1545 may be based on the received RSSI from findable device 1508. The received RSSI may indicate the distance between handheld user device 1504 and findable device 1508. The higher the RSSI value may indicate the closer the handheld user device 1504 is to findable device 1508. At L3, handheld user device 1504 may be far from findable device 1508, and as such, the radius of circle 1540 or the thickness of the donut 1545 may be small. The textual portion 534 may include text information indicating that the device being located is a “Stylus,” handheld user device 1504 is “far” from the findable device 1508, the signal strength is “weak” but “increasing,” and may encourage the user to “keep moving.”

At 1515, handheld user device 1504 may be located at L3 at time S3. Handheld user device 1504 may turn into landscape orientation. Even though the screen might be locked, user interface 1530 may rotate to adjust the textual portions 1534 or graphical portions 1536 based on the orientation of handheld user device 1504.

The received RSSI at 1515 may be higher than the received RSSI at 1505. The inner circle 1540 may have a larger radius than that at 1505. Similarly, the outer donut 1545 may have a larger thickness at 1515 than that at 1505. The textual portion 534 may include textual information indicating that the device being located is a “Stylus,” handheld user device 1504 is “hear,” e.g., very little distance from the findable device 1508, the signal strength is “strong,” and may indicate to the user that they are “there.”

### Direction Indication

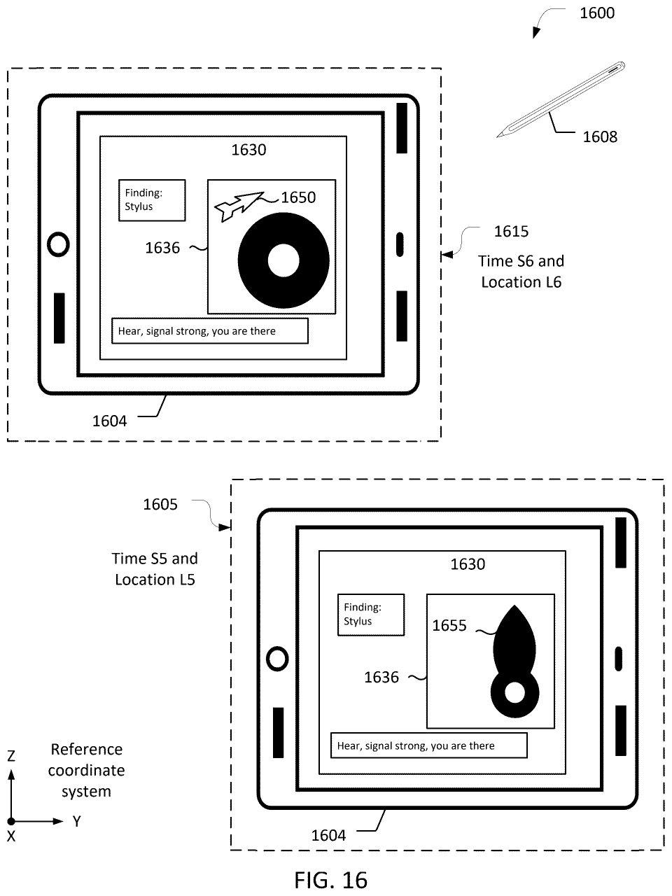

FIG. 16 illustrates examples of graphical interfaces 1600 in accordance with some embodiments. Handheld user device 1604 may be an example of handheld user device 104. A finding process may be running on handheld user device 1604 to locate findable device 1608. Findable device 1608 may be an example of findable device 108.

User interface 1630 may be an example of user interface 130 or 1530. The graphical portion 1636 of user interface 1630 may include an image that may indicate the relative location of findable device 1608 with respect to the location of handheld user device 1604.

In one example, at 1605, handheld user device 1604 may be at location L5 at time S5. The graphical portion 1636 may include a shape with a pointer, e.g., a pointing end, where the pointing end may point to the location of findable device 1608. As the user moves, the size of the shape may indicate the distance to findable device 1608, and the pointing end of the shape may indicate the direction of movement towards findable device 1608, e.g., the location of findable device 1608. The continuous measurement and location estimation may allow handheld user device 1604 to update the size and direction of the image continuously, e.g., with every new measurement or update in the location of findable device 1608.

In another example, at 1615, handheld user device 1604 may be at location L6 at time S6. The graphical portion 1636 may include images indicating the distance to findable device 1608, e.g., similar to those in FIG. 15. In addition, the graphical portion 1636 may include an arrow 1650 indicating the relative location of findable device 1608 with respect to the location of handheld user device 1604. The direction of arrow 1650 may continuously be updated based on the new measurements and location estimations.

### Indication to Change Orientation

As explained above, at the time of manufacturing or calibration, information related to each antenna may be obtained and stored in the handheld user device. The information may include the power offset, e.g., a power drop, associated with each antenna based on the handheld user device orientation, e.g., table 255 in FIG. 2.

The handheld user device may determine one or more preferred antennas at one or more orientations. The preferred antennas or orientations may be associated with an application. For example, the handheld user device may use the configured information to determine one or more preferred antennas at one or more orientations associated with finding the application.

When the handheld user device is running the finding application, the handheld device, e.g., the finding application, may determine the orientation of the handheld user device. The handheld user device may also determine that the orientation of the handheld user device is not one of the preferred orientations. The finding application may generate and display a message to suggest or instruct the user to change the orientation of the handheld user device to a preferred orientation.

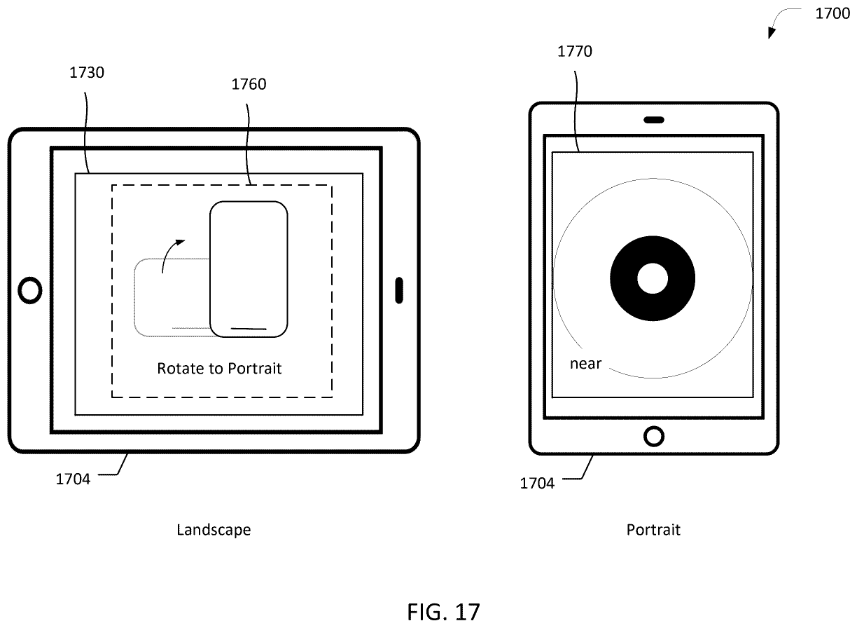

FIG. 17 illustrates examples of graphical interfaces depicting user interface information 1700 in accordance with some embodiments. Handheld user device 1704 may be an example of handheld user device 104 or other handheld user devices described above. Handheld user device 1704 may include a screen to display a user interface 1730. User interface 1730 may be an example of user interface 130 or other user interfaces described above.

When handheld user device 1704 is in landscape orientation, handheld user device 1704 may determine that the preferred orientation is portrait orientation. A message 1760 may be displayed on the user interface 1730. The message 1760 may include user interface elements, e.g., graphics or images, to visually suggest or instruct the user to change the orientation of handheld user device 1704 to a preferred orientation, e.g., portrait. Message 1760 may also include a textual component to suggest or instruct the user to change the orientation of handheld user device 1704 to a preferred orientation. In some embodiments, the user interface 1730, including the message 1760, may be determined by the handheld user device 1704 as part of implementing techniques described herein. For example, the user interface 1730 may prompt the user to change the orientation to a preferred orientation for finding accessory devices. Thus, depending on the placement of the antennas (e.g., the specific SKU), typical user grip (e.g., how users typically hold handheld user devices), and/or predicted or measured antenna occlusion, the handheld user device 1704 may determine that one orientation would be better for finding, and may prompt the user to rotate to the other orientation.

In some embodiments, message 1760 may be displayed for a configured duration. After displaying message 1760 for the configured duration, message 1760 may disappear, and the location information of the findable device may be displayed on the screen. In other embodiments, message 1760 may remain on the screen until the user changes the device's orientation to a preferred orientation.

In some embodiments, once the orientation is changed to a preferred orientation, e.g., portrait orientation in FIG. 17, a user interface 1770 may be displayed for finding or locating the findable device. The user interface 1770 is an example of the user interfaces described in FIGS. 15 and 16.

### Processes

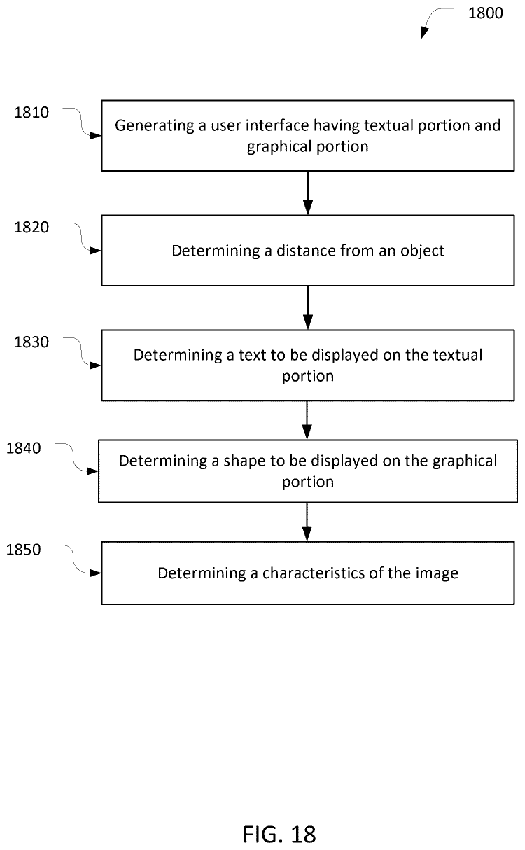

FIG. 18 illustrates a flow diagram depicting process 1800 in accordance with some embodiments. The flow diagram 1800 may be performed or implemented by a handheld user device, such as the handheld user device 104, or components thereof, such as process 140 or controller 2100.

Process 1800 may include, at 1810, generating a user interface to be displayed on the screen of a handheld user device. The user interface may include a textual portion or a graphical portion.

Process 1800 may include, at 1820, determining a distance between a findable device and the handheld user device based on a received signal from the findable device. The received signal may be an ultra-wideband (UWB) signal or Bluetooth signal. For example, the signal may be Bluetooth or Bluetooth Low Energy (BLE) rapid advertisement packets.

Process 1800 may include, at 1830, determining a text to be displayed on the textual portion of the user interface based on the received signal. The signal strength of the received signal may indicate the distance between the findable device and the handheld user device. If the estimated distance is larger than a first threshold, the textual portion may indicate that the findable device is “far” from the user's location. If the estimated distance is between the first and second threshold, the textual portion may indicate that the findable device is “near” the user's location. If the estimated distance is less than the second threshold, the textual portion of the user interface may indicate that the user is “there” and should be able to locate the findable device.

The signal may include information about the device identifier. The textual portion of the user interface may display information about the findable device obtained from the received signals.

Process 1800 may include, at 1840, determining one or more images having one or more characteristics. One or more images may be displayed on the graphical portion of the user interface. One or more characteristics of the image may include size, color, shade, and orientation or direction of pointy ends.

Process 1800 may include, at 1850, determining one or more characteristics of one or more images based on the signal. The signal may determine the distance between the handheld user device and the findable device. The characteristics of the images may be determined based on the distance. For example, as the distance between the handheld user device and the findable device decreases, the color of the shape may become a warmer color, e.g., more towards red or orange color, or the color may become a darker shade of the initial or base color. Similarly, as the distance increases, the color may become a cooler color, e.g., more towards blue, or the color may become a lighter shade of the initial base color. In another example, the shape may get bigger as the distance decreases. Similarly, as the distance increases, the shape may get smaller.

In some embodiments, the shape may indicate the direction of the findable device. The handheld user device may determine the location of the findable device based on the received signal and update the image's directionality based on the findable device's location.

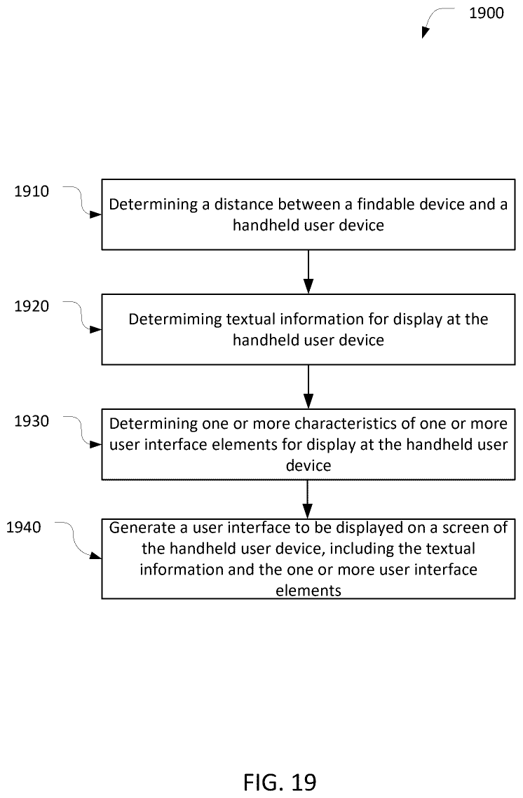

FIG. 19 illustrates a flow diagram for a process 1900 in accordance with some embodiments. The process 1900 may be performed or implemented by a handheld user device, such as the handheld user device 104, or components thereof, such as process 140 or controller 2100.

Process 1900 may include, at block 1910, determining the distance between a findable device and a handheld user device. For example, process 1900 may determine the distance based on the received signal and a pathloss estimate. In another example, process 1900 may determine the distance based on the time of flight and speed of light.

Process 1900 may determine the distance between a findable device and the handheld user device based on a received signal from the findable device. The received signal may be an ultra-wideband (UWB) signal or Bluetooth signal. For example, the signal may be Bluetooth or Bluetooth Low Energy (BLE) rapid advertisement packets.

Process 1900 may include, at block 1920, determining textual information for display on the handheld user device. The textual information may be displayed on a textual portion of the user interface. The signal strength of the received signal may indicate the distance between the findable device and the handheld user device. If the estimated distance is larger than a first threshold, the textual information may include the string “far” and may indicate that the findable device is “far” from the user's location. Suppose the estimated distance is between the first and second thresholds. In that case, the textual information may include the string “near” and may indicate that the findable device is “near” the user's location. If the estimated distance is less than the second threshold, the textual information of the user interface may include the string “there” and may indicate that the user is “there” and should be able to locate the findable device.

The signal may include information about the device identifier. The textual portion of the user interface may display textual information about the findable device obtained from the received signals.

Process 1900 may include, at 1930, determining one or more characteristics of one or more user interface elements for display on the handheld user device. One or more user interface elements may be displayed on the graphical portion of the user interface. One or more characteristics of one or more user interface elements may include size, color, shade, and orientation or direction of pointy ends.

Process 1900 may include, at 1940, generating a user interface to be displayed on the screen of the handheld user device. The user interface may include textual information and the one or more user interface elements.

In some embodiments, the shape may indicate the direction of the findable device. The handheld user device may determine the location of the findable device based on the received signal and update the image's directionality based on the findable device's location.

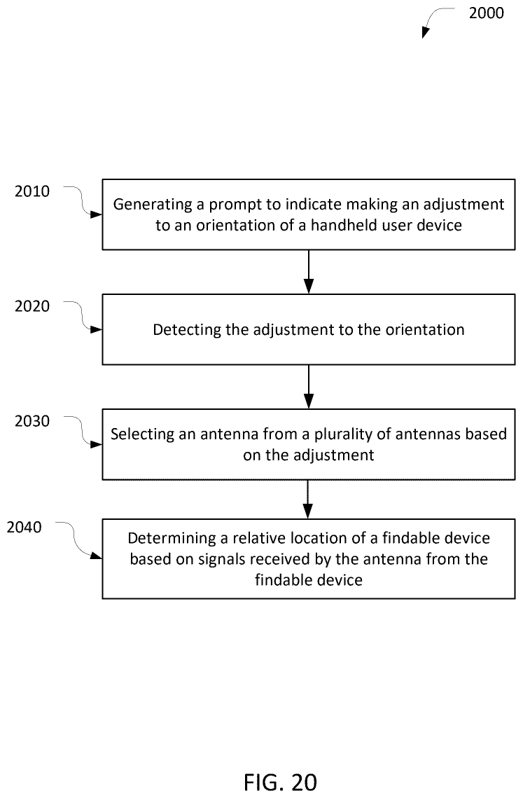

FIG. 20 illustrates a flow diagram for a process 2000 in accordance with some embodiments. The process 2000 may be performed or implemented by a handheld user device, such as the handheld user device 104, or components thereof, such as process 140 or controller 2100.

Process 2000 may include, at block 2010, generating a prompt to indicate making an adjustment to an orientation of a handheld user device. The prompt may be displayed on the handheld user device's screen using the user interface. In some examples, the prompt may be a message (e.g., message 1760) displayed on a user interface (e.g., user interface 1730). The prompt can instruct the user to adjust the orientation of the handheld user device to an orientation that is preferred or more suitable for locating a findable device.

Process 2000 may include, at block 2020, detecting the adjustment to the orientation of the handheld user device. The handheld user device can detect that the orientation is now in a preferred orientation. In some examples, the handheld user device can detect the adjust to the orientation using signals from an accelerometer, a gyroscope, a magnetometer, or other sensor of the handheld user device.

Process 2000 may include, at block 2030, selecting an antenna from a plurality of antennas based on the adjustment. In some examples, the handheld user device may use a configured lookup table and the orientation of the handheld user device to select the antenna. In some examples, the handheld user device may determine a received signal strength indicator (RSSI) for each of the plurality of its antennas and select the antenna with the largest RSSI (as described above with respect to FIG. 4).

Process 2000 may include, at block 2040, determining a relative location of a findable device based on signals received by the antennas from the findable device. The handheld user device may use signals received from the findable device to determine the relative location. For example, the handheld user device may measure the RSSI of signals received from the findable device on one or more channels to determine the location of the findable device with respect to the location of the handheld user device (as described above with respect to FIG. 6).

In some examples, the handheld user device can determine that a current orientation of the handheld user device is a preferred orientation and omit the generating the prompt before proceeding to determining the relative location of the findable device. For example, if the handheld user device is in a portrait orientation,

### IV. Example Device

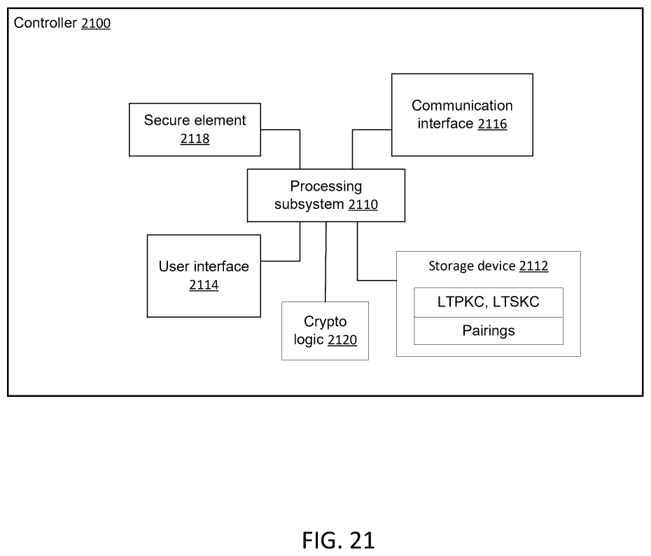

FIG. 21 is a block diagram of an example device according to the embodiments of the present disclosure. FIG. 21 is a block diagram of a controller 2100 according to some embodiments. Controller 2100 may be included in a user device, a controller device, a resident device, a hub device, an accessory device, vehicle entertainment center, wearable device (e.g., smartwatch, headset, etc.), or any other suitable electronic device. Controller 2100 may implement any or all of the controller functions, behaviors, and capabilities described herein, and other functions, behaviors, and capabilities not expressly described.

For example, the application of the home automation system may be executed on the processing subsystem 2110, which may cause the communication interface 2116 to use the protocol and technology associated with the LAN for transmissions related to updating a primary location.

Controller 2100 may include processing subsystem 2110, storage device 2112, user interface 2114, communication interface 2116, secure element 2118, and cryptographic logic module 2120. Controller 2100 may also include other components (not explicitly shown), such as a battery, power controllers, and other components operable to provide various enhanced capabilities. In various embodiments, controller 2100 may be implemented in a desktop computer, laptop computer, tablet computer, smartphone, wearable computing device, or other systems having any desired form factor. Further, as noted above, controller 2100 may be implemented partly in a base station and partly in a mobile unit that communicates with the base station and provides a user interface.

Storage device 2112 may be implemented, e.g., using disk, flash memory, or any other non-transitory storage medium, or a combination of media, and may include volatile or nonvolatile media. In some embodiments, storage device 2112 may store one or more application or operating system programs to be executed by processing subsystem 2110, including computer-executable instructions or programs to implement any or all operations described herein as being performed by a controller. The storage device 2112 may include a non-transitory computer-readable medium to store computer-executable instruction or programs. The processing subsystem 2110 may include one or more processors configured to access the storage device 2112. For example, storage device 2112 may store a uniform controller application that may read an accessory definition record and generate a graphical user interface for controlling the accessory based on the information therein. In some embodiments, portions (or all) of the controller functionality described herein may be implemented in operating system programs rather than applications. In some embodiments, storage device 2112 may also store apps designed for specific accessories or specific categories of accessories (e.g., an IP camera app to manage an IP camera accessory or a security app to interact with door lock accessories).

User interface 2114 may include input devices such as a touchpad, touch screen, scroll wheel, click wheel, dial, button, switch, keypad, microphone, or the like, as well as output devices such as a video screen, indicator lights, speakers, headphone jacks, or the like, together with supporting electronics (e.g., digital to analog or analog to digital converters, signal processors, or the like). A user may operate input devices of user interface 2114 to invoke the functionality of controller 2100 and may view or hear output from controller 2100 via output devices of user interface 2114.

Processing subsystem 2110 may be implemented as one or more integrated circuits, e.g., one or more single-core or multi-core microprocessors or microcontrollers, examples of which are known in the art. In operation, processing subsystem 2110 may control the operation of controller 2100. In various embodiments, processing subsystem 2110 may execute programs in response to program code and maintain multiple concurrently executing programs or processes. At any given time, some or all of the program code to be executed may be resident in processing subsystem 2110 or in storage media such as storage device 2112.

Through suitable programming, processing subsystem 2110 may provide various functionality for controller 2100. For example, in some embodiments, processing subsystem 2110 may implement various processes (or portions thereof) described above as being implemented by a controller. Processing subsystem 2110 may also execute other programs to control other functions of controller 2100, including programs that may be stored in storage device 2112. In some embodiments, these programs may interact with an accessory, e.g., by generating messages to be sent to the accessory or receiving messages from the accessory. Such messages may conform to a uniform accessory protocol as described above.

Communication interface 2116 may provide voice or data communication capability for controller 2100. In some embodiments, communication interface 2116 may include radio frequency (RF) transceiver components for accessing wireless voice or data networks (e.g., using cellular telephone technology, data network technology such as 5G, 4G/LTE, Wi-Fi® (IEEE 802.11 family standards), or other mobile communication technologies, or any combination thereof), components for short-range wireless communication (e.g., using Bluetooth® or Bluetooth® LE standards, NFC, etc.), or other components. In some embodiments, communication interface 2116 may provide wired network connectivity (e.g., Ethernet) in addition to or instead of a wireless interface. Communication interface 2116 may be implemented using a combination of hardware (e.g., driver circuits, antennas, modulators/demodulators, encoders/decoders, and other analog or digital signal processing circuits) and software components. In some embodiments, communication interface 2116 may support multiple communication channels concurrently, using the same transport or different transports.

The secure element 2118 may be an integrated circuit or the like that may securely store cryptographic information for controller 2100. Examples of information that may be stored within the secure element 2118 include the controller's long-term public and secret keys (LTPKC, LTSKC as described above), and a list of paired accessories (e.g., a lookup table that maps accessory ID to accessory long-term public key LTPKA for accessories that have completed a pair setup or pair add process as described above).

In some embodiments, cryptographic operations may be implemented in a cryptographic logic module 2120 that communicates with the secure element 2118. Physically, cryptographic logic module 2120 may be implemented in the same integrated circuit with the secure element 2118 or a different integrated circuit (e.g., a processor in processing subsystem 2110) as desired. Cryptographic logic module 2120 may include various logic circuits (fixed or programmable as desired) that implement or support cryptographic operations of controller 2100, including any or all cryptographic operations described above. The secure element 2118 or cryptographic logic module 2120 may appear as a “black box” to the rest of controller 2100. Thus, for instance, communication interface 2116 may receive a message in an encrypted form that it cannot decrypt and may simply deliver the message to processing subsystem 2110. Processing subsystem 2110 may also be unable to decrypt the message, but it may recognize the message as encrypted and deliver it to cryptographic logic module 2120. Cryptographic logic module 2120 may decrypt the message (e.g., using information extracted from the secure element 2118) and determine what information to return to processing subsystem 2110. As a result, certain information may be available only within the secure element 2118 and cryptographic logic module 2120. If secure element 2118 and cryptographic logic module 2120 are implemented on a single integrated circuit that executes code only from a secure internal repository, this may make extracting the information extremely difficult, providing a high degree of security. Other implementations are also possible.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld user devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C#or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein is merely intended to serve as a shorthand method of referring individually to each separate value falling within the range unless otherwise indicated herein, and each separate value is incorporated into the specification as if it were individually recited herein. All methods described herein can be performed in any suitable order unless otherwise indicated herein or otherwise clearly contradicted by context. The use of any and all examples or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. The phrase “based on A” means “based at least in part on A,” for example, it could be “based solely on A,” or it could be “based in part on A.”

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Flow diagrams, as illustrated herein, provide examples of sequences of various process actions. The flow diagrams can indicate operations to be executed by a software or firmware routine and physical operations. A flow diagram can illustrate an example of the implementation of states of a finite state machine (FSM), which can be implemented in hardware or software. Although shown in a particular sequence or order, the order of the actions can be modified unless otherwise specified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, or data. The content can be directly executable (“object” or “executable” form), source code, or difference code (“delta” or “patch” code). The software content of what is described herein can be provided via an article of manufacture with the content stored thereon or via a method of operating a communication interface to send data via the communication interface. A machine-readable storage medium can cause a machine to perform the functions or operations described and includes any mechanism that stores information in a form accessible by a machine (e.g., computing device, electronic system, etc.), such as recordable/non-recordable media (e.g., read-only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters or sending signals to prepare the communication interface to provide a data signal describing the software content. The communication interface can be accessed via one or more commands or signals sent to the communication interface.

The detailed description refers to the accompanying drawings. The same reference numbers may be used in different drawings to identify the same or similar elements. In the above description, for purposes of explanation and not limitation, specific details are set forth, such as particular structures, architectures, interfaces, or techniques, to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail.

Various components described herein can be a means for performing the operations or functions described. Each component herein includes software, hardware, or a combination. The components can be implemented as software modules, hardware modules, special-purpose hardware (e.g., application-specific hardware, application-specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative and not restrictive sense. The scope of the invention should be measured solely by reference to the claims that follow.

Although the aspects above have been described in considerable detail, numerous variations and modifications will become apparent to those skilled in the art once the above disclosure is fully appreciated. Accordingly, the following claims are intended to be interpreted to embrace all such variations and modifications.

### Privacy

As described above, one aspect of the present technology is the gathering and use of data relevant to a user's location and associated devices. The present disclosure contemplates that, in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, personal information data can be used to provide enhancements to a user's experience with mapping services. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of updating the home location of a home automation system, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method, comprising:
determining an orientation of a handheld user device, the handheld user device comprising a plurality of antennas;
selecting an antenna from among the plurality of antennas based at least in part on the orientation;
processing signals received by the antenna from a findable device; and
determining a relative location of the findable device with respect to a location of the handheld user device based on the signals.

2. The method of claim 1, wherein determining the orientation of the handheld user device comprises:
generating a prompt to indicate making an adjustment to the orientation; and
detecting the adjustment to the orientation.

3. The method of claim 1, further comprising:
generating a prompt to indicate making an adjustment to a grip;
detecting the adjustment to the grip; and
selecting the antenna based on the adjustment.

4. The method of claim 1, wherein the findable device is an accessory device.

5. The method of claim 1, wherein determining the orientation is based on a measurement by an accelerometer, a gyroscope, or a magnetometer.

6. The method of claim 1, further comprising:
determining a received signal strength indicator (RSSI) associated with the antenna; and
determining a grip drop associated with the antenna.

7. The method of claim 6, wherein determining the grip drop is based on a configured lookup table.

8. The method of claim 6, wherein selecting the antenna comprises determining that the grip drop of the antenna is smaller than grip drop of at least one other antenna of the plurality of antennas.

9. The method of claim 1, further comprising determining an antenna pattern of the antenna.

10. The method of claim 9, wherein the selection of the antenna is based on the antenna pattern of the antenna.

11. The method of claim 1, further comprising:
determining that a received a signal strength indicator (RSSI) of the antenna is greater than RSSIs of other antennas of the plurality of antennas, wherein selecting the antenna is based on the determination that the RSSI of the antenna is greater than the RSSI of other antennas of the plurality of antennas.

12. One or more non-transitory computer-readable media comprising computer executable instructions that, when executed by one or more processors of a handheld user device, cause the handheld user device to at least:
determine an orientation of the handheld user device, the handheld user device comprising a plurality of antennas;
select an antenna from among the plurality of antennas based at least in part on the orientation;
process signals received by the antenna from a findable device; and
determine a relative location of the findable device with respect to a location of the handheld user device based on the signals.

13. The one or more non-transitory computer-readable of claim 12, further comprising additional computer-executable instructions that, when executed by the one or more processors, cause the handheld user device to further:
determine a received signal strength indicator (RSSI) associated with the antenna; and
determine a grip drop associated with the antenna.

14. The one or more non-transitory computer-readable of claim 13, wherein selecting the antenna comprises determining that the grip drop of the antenna is smaller than grip drop of other antennas of the plurality of antennas.

15. The one or more non-transitory computer-readable of claim 12, further comprising additional computer-executable instructions that, when executed by the one or more processors, cause the handheld user device to further determine an antenna pattern of the antenna.

16. A handheld user device, comprising:
a plurality of antennas;
a memory configured to store computer-executable instructions; and
a processor configured to access the memory and execute the computer-executable instructions to at least:
determine an orientation of the handheld user device;
select an antenna from among the plurality of antennas based at least in part on the orientation;
process signals received by the antenna from a findable device; and
determine a relative location of the findable device with respect to a location of the handheld user device based on the signals.

17. The handheld user device of claim 16, wherein determining the orientation of the handheld user device comprises:
generating a prompt to indicate making an adjustment to the orientation; and
detecting the adjustment to the orientation.

18. The handheld user device of claim 16, wherein the memory is configured to store additional computer-executable instructions that, when executed by the processor, cause the handheld user device to further:
determine a received signal strength indicator (RSSI) associated with the antenna; and
determine a grip drop associated with the antenna.

19. The handheld user device of claim 16, wherein the memory is configured to store additional computer-executable instructions that, when executed by the processor, cause the handheld user device to further determine that a received a signal strength indicator (RSSI) of the antenna is greater than RSSIs of at least one other antenna of the plurality of antennas, and wherein selecting the antenna is based on the determination that the RSSI of the antenna is greater than the RSSI of the at least one other antenna of the plurality of antennas.

20. The handheld user device of claim 16, wherein the memory is configured to store additional computer-executable instructions that, when executed by the processor, cause the handheld user device to further:
generate a prompt to indicate making an adjustment to a grip;
detect an adjustment to the grip; and
select the antenna based on the adjustment.
